(19) United States
(12) Patent Application Publication
(10) Pub. No.: US 2026/0350094 A1
(43) Pub. Date: Nov. 5, 2026

(54) UNIVERSALLY-PLUGGABLE AGENTIC WORKFLOW ENGINE WITH TEMPLATIZED CONNECTOR STRUCTURES

(71) Applicant: The Dot Net Factory, LLC., Dublin, OH (US)

(72) Inventor: Patrick Henry PARKER, Sarasota, FL (US)

(73) Assignee: The Dot Net Factory, LLC., Dublin, OH (US)

(21) Appl. No.: 19/410,918

(22) Filed: Dec. 5, 2025

Related U.S. Application Data
(60) Provisional application No. 63/799,014, filed on May 2, 2025.

(51) Int. Cl. G06F 16/901; G06F 11/3604; G06F 12/0891; G06F 16/21; G06N 3/0475; H04L 9/32; H04L 9/40; H04L 69/16

(52) U.S. Cl. CPC G06F 16/9024; G06F 11/3612; G06F 12/0891; G06F 16/211; G06N 3/0475; H04L 9/3239; H04L 63/0807; H04L 69/162

(57) ABSTRACT

An agent-centric workflow system includes a workflow engine operable to receive a workflow identifier and return a self-describing, zero-shot task payload. The workflow engine includes a next path generator operable to identify a possible next step in an identified workflow, dependencies between nodes of the identified workflow, and a consequence of the possible next step in order to construct a dynamically-generated next path map, and an agent context manager operable to construct the self-describing, zero-shot task payload including an executable request template, natural-language guidance, and success-criteria metadata for the possible next step. The system further includes a large language model (LLM) agent including a natural language processor and operable to receive a machine-readable response and execute the self-describing, zero-shot task payload in a zero-shot execution.

### CROSS-REFERENCE TO RELATED APPLICATIONS

This application claims priority to and the benefit of the provisional patent application titled “UNIVERSALLY-PLUGGABLE AGENTIC WORKFLOW ENGINE WITH TEMPLATIZED CONNECTOR STRUCTURES”, application number 63/799,014, filed in the United States Patent and Trademark Office on May 2, 2025. The specification of the above-referenced patent application is incorporated herein by reference in its entirety.

### TECHNICAL FIELD OF THE DISCLOSURE

The present disclosure relates generally to AI-based workflow execution for enterprise systems.

### BACKGROUND OF THE DISCLOSURE

For enterprise systems that include various access credentials for roles spanning from IT managers to temporary contractors, identity management solutions have become a cornerstone for ensuring secure and efficient access to these systems and services. These identity management solutions are utilized to manage user identities, authenticate access, and enforce security policies across one or more platforms. However, the integration of identity management systems with other enterprise applications can present numerous challenges, particularly due to the varying syntaxes of application programming interfaces (APIs) and the specialized requirements of prompt engineering in AI-based workflows.

APIs often serve as the primary means for different software systems to communicate and interact. Despite widespread use, the majority of APIs often lack standardization, such that a multitude of syntaxes and protocols are employed across the varying interfaces. The lack of uniform standards can lead to increased complexity and inefficiency when integrating identity management solutions with other applications. To bridge the gaps between identity management systems and each new API, developers are tasked with writing extensive custom codes, which can be time-consuming and prone to errors.

Further, the increased adoption of artificial intelligence (AI) in identity management solutions has introduced further complications and considerations related to workflow automation and optimization. AI-based add-ons can be designed to enhance productivity by automating routine tasks, providing informed insights, and facilitating decision-making processes. However, the effectiveness of these AI-based solutions can be dependent on prompt engineering, or the process of designing and refining the inputs, or prompts, that guide the AI's responses. Specialized prompt engineering can be essential to ensure that AI systems deliver accurate and relevant outputs for AI-based solutions, but can introduce another layer of complexity to the integration process as each new API-integration can require a new specialized prompt or further training.

As such, the integration of AI-based solutions with an increasing number of specialized API protocols can be time-consuming, computationally-expensive, and can prevent the rapid adoption of AI-based solutions for identity management solutions.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an aspect of the present disclosure, an agent-centric workflow system includes a workflow engine operable to receive a workflow identifier and return a self-describing, zero-shot task payload. The workflow engine includes a next path generator operable to identify a possible next step in an identified workflow, dependencies between nodes of the identified workflow, and a consequence of the possible next step in order to construct a dynamically-generated next path map, and an agent context manager operable to construct the self-describing, zero-shot task payload including an executable request template, natural-language guidance, and success-criteria metadata for the possible next step. The system further includes a large language model (LLM) agent including a natural language processor and operable to receive the machine-readable response and execute the self-describing, zero-shot task payload in a zero-shot execution.

In another aspect, an execution gateway for identity management systems includes a pluggable policy enforcement point operable to communicate a pending task payload with and receive a denial decision from an external policy-decision point, and a redaction engine in communication with the pluggable policy enforcement point, the redaction engine operable to utilize the denial decision to sanitize one or more unauthorized operations from the pending task payload to construct a sanitized payload, wherein the pluggable policy enforcement point further communicates the sanitized payload to the external policy-decision point for a further request.

In a further aspect, a computer-implemented method for constructing a connector for a target API includes receiving external interface metadata for the target application programming interface (API), parsing the external interface metadata in an artificial intelligence (AI)-based construction engine to extract instructions, constraints, states, and success criteria for a workflow, generating, via the AI-based construction engine, an executable YAML Ain't Markup Language (YAML, recursive abbreviation) connector including definitions and associated workflow nodes using the instructions, constraints, states, and success criteria, and registering the executable YAML connector for immediate runtime use without re-deploying the system.

In an additional aspect, a template-based connector architecture includes a multi-pass renderer for receiving a YAML connector and rendering strings, dictionaries, and lists of the YAML connector recursively while validating types, substituting secrets, and caching compiled templates, and a unified execution engine configured to translate a plurality of heterogenous protocols of the YAML connector into a single JavaScript object notation (JSON) request or response surface.

In a still further aspect, a template-based connector architecture includes a multi-pass renderer for receiving a YAML connector and rendering strings, dictionaries, and lists of the YAML connector recursively while validating types, substituting secrets, and caching compiled templates, a unified execution engine configured to translate a plurality of heterogenous protocols of the YAML connector into a single JSON request or response surface, and a bidirectional adapter configured to consume external model context protocol (MCP) tools via construction of local YAML connectors and expose internal commands or workflow as MCP endpoints, wherein each invocation of the internal commands or workflows is secured under a user-bound-agent token.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A-1B are example systems for enabling agentic consumption of workflows for identity management systems with a zero-shot approach, according to one or more embodiments of the present disclosure.

FIG. 2 is an example system for autonomously adding new API-specific workflow capabilities for execution by an LLM agent, according to one or more embodiments of the present disclosure.

FIG. 3 is a schematic view of an authorization system using universal authorization layer for performing policy-aware execution of payloads, according to one or more embodiments of the present disclosure.

FIG. 4 is an example method for executing a workflow via an LLM agent in a zero-shot execution with only a workflow identifier as an input, according to one or more embodiments of the present disclosure.

FIG. 5 is an example method for executing a workflow via an LLM agent for a process without a pre-constructed configuration file in a zero-shot manner, according to one or more embodiments of the present disclosure.

FIG. 6 is an example method for constructing an executable YAML connector from external API documentation, according to one or more embodiments of the present disclosure.

FIG. 7 is a sample connector for an example of API-specific YAML configuration file, according to one or more embodiments of the present disclosure.

FIG. 8 is a sample machine-readable response to be used by an LLM agent in executing an identified workflow, according to one or more embodiments of the present disclosure.

FIG. 9 is an example mermaid diagram representing the construction method of a machine-readable response for executing an input workflow, according to one or more embodiments of the present disclosure.

FIG. 10 is an example of a block diagram of a system for implementing the methods disclosed herein, according to one or more embodiments of the present disclosure.

FIG. 11 is an example of a cloud computing environment that can be used for implementing one or more modules and/or systems, according to one or more embodiments of the present disclosure.

FIG. 12 illustrates a schematic diagram of an example system for implementing the methods disclosed herein, according to one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to workflow execution for enterprise systems and, more particularly, to utilizing a zero-shot AI workflow engine with LLM agents through a universal API gateway for autonomous execution of identity management system services. The disclosed systems and methods can provide an agent-centric workflow system designed to streamline the integration and execution of workflows across diverse identity management solutions while using an AI-based workflow. The system can include a workflow engine that receives a workflow identifier and returns a machine-readable response containing instructions and success criteria for execution by an AI agent. This workflow engine can further include a next path generator, which identifies possible next steps in the workflow, dependencies between workflow nodes, and the consequences of these steps. In some embodiments, the workflow engine can employ a configuration file corresponding to an API for the identified workflow, the configuration file detailing each of the instructions, success criteria, next steps, dependencies, and consequences in a YAML-based structure. Additionally, an agent context manager can utilize the configuration file to provide the current state, instructions, constraints, and success criteria for the next step, and can thus construct the machine-readable response accordingly. While the configuration files can be typically generated in a YAML format, the machine-readable responses can be provided in JSON format, which can include instructions, intermediate checks, constraints, success criteria, and examples for the LLM agent to utilize.

In the disclosed methods and systems, a LLM agent, equipped with a natural language processor, can receive the machine-readable response and execute the instructions under the specified constraints in a zero-shot execution. Unlike traditional AI-based workflow add-ons, which can require extensive prompting and specialized training, the zero-shot execution of the disclosed systems and embodiments can enable the LLM agent to execute the workflow without any prior training. The disclosed system can further include a database that stores a plurality of configuration files for various workflows, APIs, and identity providers. A connector construction engine can be included, and operable to parse documentation for APIs that lack corresponding configuration files in the database, and can thereby construct new configuration files with the necessary instructions, constraints, and success criteria for the associated workflows.

The LLM agent of the disclosed systems and methods can communicate with an identity provider or policy decision point through one or more APIs within a target system. The disclosed system can further include a universal authorization layer that normalizes access requests and enforces policies across multiple identity providers and policy decision points via the APIs. The system can thus ensure seamless communication and policy enforcement across various identity providers and policy decision points, providing a robust and efficient solution for managing complex workflows in AI-driven environments.

### Identity Management Systems and Workflows

Identity management systems can be critical components in modern information technology infrastructures, providing mechanisms for authenticating and authorizing users to access various resources within an organization. These systems are responsible for ensuring that only authorized individuals can access sensitive information and perform specific actions, thereby safeguarding the integrity and confidentiality of data. In order to manage user authorization with identity management systems, specific workflows are utilized to add and remove user privileges for various endpoints and data sources. These workflows typically involve several steps, including user authentication, role assignment, and the granting or revocation of access rights based on predefined policies. Effective management of these workflows is essential to maintain security and compliance with regulatory requirements. However, while enterprise systems can leverage and utilize a plurality of vendors and policy-decision points, identity management systems can often be limited to a single vendor, and can require extensive coding to extend to further vendors.

While AI technologies can enhance the capabilities of identity management systems by automating routine tasks, detecting anomalies, and providing predictive insights, integrating AI-based add-ons into existing identity management systems can require extensive training and prompt engineering. As various vendor-specific APIs can require diverse instructions, permissions, and constraints, the application of an AI-based add-on can demand new prompts and training data to ensure the AI correctly performs the workflow. However, the time and effort required to develop these prompts and training data can be prohibitive in efficiently incorporating agent-based workflows with new applications. Particularly, the extensive manual configuration and the possible weeks of work needed to connect an identity management system to a new application with an AI-based add-on can prevent the flexibility and growth of these identity management systems in enterprise operations.

The combination of these challenges, including diverse API syntaxes for different vendors and policy-decision points and the need for specialized prompt engineering for various integrations, can prevent the streamlining of identity management system integration with AI-based workflows. As such, a unified framework that can autonomously abstract the complexities of different APIs into machine-readable workflows and automatically execute these unique workflows in a zero-shot manner are desirable. Such a framework can not only simplify the integration process but further enhance the overall efficiency and security of identity management solutions in both human-driven and exclusively LLM agent-driven environments.

### Aspects Related to Zero-Shot AI Workflow Engines

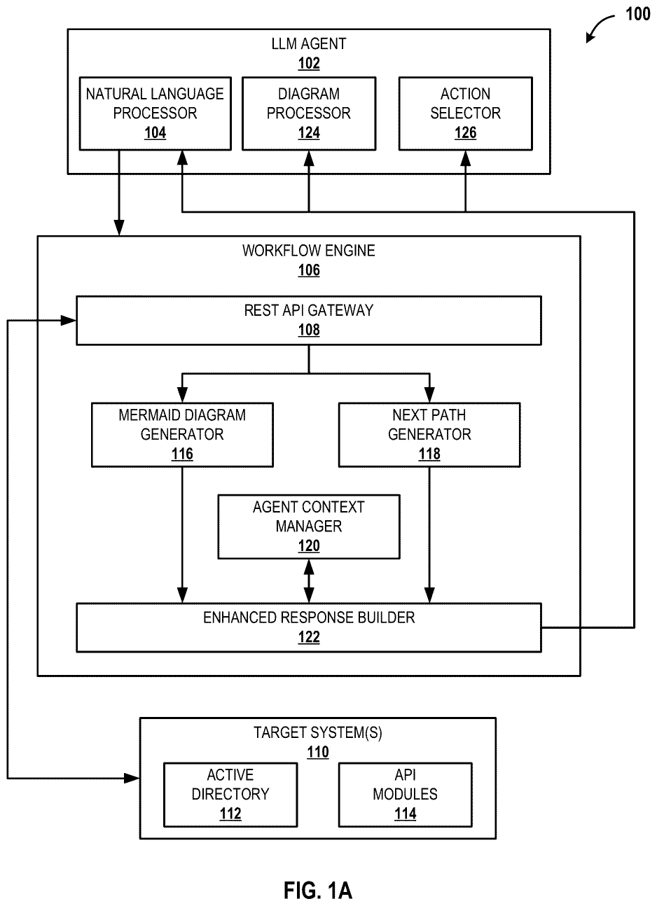

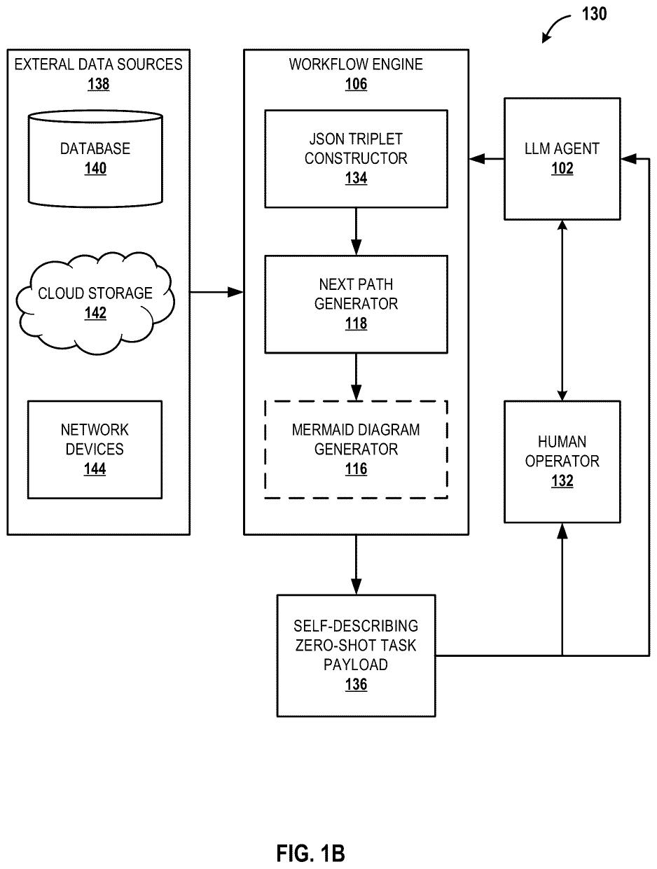

FIG. 1A is an example system 100 for enabling agentic consumption of workflows for identity management systems with a zero-shot approach. System 100 can include an LLM agent 102 operable to request, analyze, and execute instructions to carry out a workflow, such as an identity management workflow. LLM agent 102 can include a natural language processor 104 for converting natural language inputs into machine-readable instructions, as well as a diagram processor 124 for interpreting and utilizing visual diagrams, such as mermaid diagrams. In some embodiments, LLM agent 102 can further include an action selector 126 operable to utilize machine-readable instructions and make an informed decision as to an action to be taken for execution of the workflow. System 100 can further include a workflow engine 106 in communication with LLM agent 102, workflow engine 106 operable to receive a desired workflow name and provide machine-readable instructions to LLM agent 102 for performance of the workflow. To facilitate interfacing with other LLM agent 102, workflow engine 106 can include a representational state transfer (REST) API gateway 108 for enabling communication over the internet or other communication method. Workflow engine 106 can further include a mermaid diagram generator 116, a next path generator 118, and an agent context manager 120, each operable to receive and convert a configuration file into formats usable by LLM agent 102 to execute the workflow. Workflow engine 106 can accordingly include an enhanced response builder 122 for generating the machine-readable response corresponding to the input workflow name, the machine-readable response usable in execution of the workflow. System 100 can further include one or more target system(s) 110 on which the workflow is to be performed or targeting. Target system(s) 110 can include an active directory 112 in which any create, read, update, and delete (CRUD) services are to be performed, and the API modules 114 which are used for creating or amending identity policies.

LLM agent 102 can be any AI-powered system operable to perform complex operations utilizing sequential reasoning for text-based instructions, leveraging large language models in the process, using at least natural language processor 104. LLM agent 102 can be provided a workflow name or identifier (e.g., “create_user_account”) from a user or another AI system, with the workflow identifier representing a possible action to be taken against a specified API. In some embodiments, LLM agent 102 can be operable to handle user interaction steps, action steps executed against external systems, function steps executed via internal functions (e.g., Python functions), and perform parallel processing of collection steps. LLM agent 102 can be communicatively coupled to workflow engine 106, either through a direct connection or through REST API gateway 108. Accordingly, LLM agent 102 can provide the workflow name or identifier to workflow engine 106 to prompt the return of a machine-readable response to execute processes mapped to the workflow name or identifier.

In some embodiments, REST API gateway 108 can power all code-free integrations and AI-driven workflows of system 100 using a single, minimal REST surface. The REST surface can delegate credential handling, policy checks, and connector logic to pluggable micro-components without exposing the complexity of underlying system 100 to LLM agent 102 or any operators. REST API gateway 108 can provide a single, schema-agnostic API that any client or LLM agent can call, while workflow engine 106 transparently handles credentials, authorization, and protocol translation therethrough. REST API gateway 108 can include three endpoints for the public API surface, each endpoint using hypertext transfer protocol (HTTP) “POST” methodology to perform the three actions. The three endpoints can enable the running of a single command on a target system 110, the start of a graph workflow with multiple steps in workflow engine 106, and the submission of data to a user-interaction task. REST API gateway 108 can accordingly utilize a single engine pluggable with any policy decision point, identity provider, or vault through YAML configurations, env variables, and token introspection mapping. As such, clients for system 100 can be zero-knowledge clients without knowing base uniform resource locators (URLs), authorization flows or schemas, while system 100 itself can execute any plug-in operations before any connector calls are executed.

REST API gateway 108 may implement conditional “GET” processing for catalog and resource endpoints. An entity tag (ETag) may be computed as a secure hash algorithm 256-bit (SHA-256) digest of a canonical JSON serialization of the response, and the REST API gateway 108 may track directory modification times to populate “Last-Modified” headers. When a client presents an “If-None-Match” value that matches the current ETag, REST API gateway 108 may return a 304 Not Modified response with corresponding validators and Cache-Control directives that may include stale-while-revalidate. This reuse of HTTP validators may reduce bandwidth consumption and server work for unchanged resources and may curb interconnect load and I/O traffic.

As such, workflow engine 106 can access a stored configuration file outlining the corresponding workflow, and can further employ mermaid diagram generator 116 and next path generator 118 to parse the configuration file into actionable next steps and a visual representation of the workflow sate and decision paths. Mermaid diagram generator 116 can accordingly construct color-coded visual representations with edge labeling that account for decision conditions, which can be inherently understood by human operators, while also being usable by LLM agent 102 through diagram processor 124. The mermaid diagrams constructed by mermaid diagram generator 116 can represent the entire workflow, regardless of a current state, with each step (or node) including a corresponding status for the current state. In conjunction with mermaid diagram generator 116, a compact representation of decision paths may compress state and reduce redundant evaluation during execution. Mermaid-compatible graphs with node-level status may encode path conditions and dependencies as short strings that diagram processor 124 can interpret without expanding full rule sets on each loop. This representation may reduce payload size for state transitions, improve cache locality for decision metadata, and shorten per-step evaluation time for LLM agent 102 when assessing available next actions.

Similarly, next path generator 118 can identify the next step(s) to be taken based upon the current state of the workflow, including the decided next step, any nodes of the workflow triggered by the next step, an explanation of why the step was chosen, and any associated metadata (e.g., for parallel executions). Next path generator 118 can be utilized in tandem with mermaid diagram generator 116 to visualize all possible next steps, identify the chosen next step, and provide any related data and state information related to the chosen path. As such, the next step of the prompted workflow can be dynamically determined in workflow engine 106, while pre-evaluating any necessary conditions and providing explanations for the consequences of the step. Next path generator 118 can perform these functions for both the workflow as a whole, as well as for each specific node of the workflow. In some embodiments, next path generator 118 can be utilized to assess the entire workflow and identify steps that are available and permissible to be executed, as well as detailed explanations of consequences for each step in the workflow. In these embodiments, next path generator 118 can enable the construction of comprehensive execution roadmaps from the configuration file to guide LLM agent 102 through the complex processes of the workflow without any prior training or knowledge of the workflow or associated system. Thus, next path generator 118, along with the stored configuration file, can enable LLM agent 102 to execute the workflow in a zero-shot manner.

During construction of next steps and mermaid diagrams for use by LLM agent 102, workflow engine 106 can further leverage an agent context manager 120 to aid in forming machine-readable instructions executable by LLM agent 102. Agent context manager 120 can communicate with an enhanced response builder 122, which can itself receive mermaid diagrams and next path information from mermaid diagram generator 116 and next path generator 118, respectively. Agent context manager 120 can be operable to provide explicitly structured instructions corresponding to the next path information, while further providing clear constraints of the workflow that can guide decision-making of LLM agent 102. In some embodiments, agent context manager 120 can further specify the desired success criteria that LLM agent 102 can use to measure accomplishment of the desired next step, while also providing a list of explicitly-allowed decisions to be made to prevent unexpected actions by LLM agent 102. In further embodiments, agent context manager 120 can receive information regarding the specific LLM agent 102 requesting the workflow, and can include protocol-specific guidance based on the type or limitations of LLM agent 102 executing the workflow. Thus, agent context manager 120 can ensure that LLM agent 102 performs the workflow within defined boundaries found in the configuration file, while also enabling LLM agent 102 to have a degree of flexibility for more complex scenarios. Further, agent context manager 120 can track a state of the workflow across multiple steps, such that agent context manager 120 provides LLM agent 102 with a persistent memory of prior steps taken and corresponding results.

Workflow engine 106 can provide all interpreted information and data regarding next steps, limitations, inputs, and possible paths to enhanced response builder 122. Enhanced response builder 122, in concert with agent context manager 120, can construct an AI-focused response that can enable LLM agent 102 to perform the workflow tasks autonomously without additional prompting, and without any initial training. In some embodiments, enhanced response builder 122 can primarily convert interpreted instructions from the configuration file to form a machine-readable response in a desired format (e.g., a JSON file). In these embodiments, enhanced response builder 122 can differ from traditional systems, which provide human-facing forms or unstructured text in response to a workflow request. While the aforementioned configuration file can be provided as a human-readable YAML connector file, the machine-readable format constructed by enhanced response builder 122 can be tailored to specifically guide untrained LLM agent 102 through the desired steps.

In some embodiments, enhanced response builder 122 can leverage a deterministic transformation pipeline in place of AI-based conversion. In an initial configuration, enhanced response builder 122 extracts essential fields from raw input dictionaries (e.g., via a “coerce_to_enhanced_result( )” function). Similarly, any nested dictionaries can be flattened therein to construct a consistent, single-level structure from which to build the enhanced response. In this initial configuration, enhanced response builder 122 can separate top-level API fields such as status, message, and correlation ID from the remainder of the content provided to enhanced response builder 122. Using the extracted, normalized structure, enhanced response builder 122 can enhance the context of the provided raw data in order to enhance the value of the output response for downstream consumers. In these embodiments, helper functions (e.g., “build_required_action( )” or “extract_validation_rules( )”) can be employed to produce specific instructions, templates, or requirements to aid the construction of the enhanced response, and further aid in converting the YAML connector file to specific action items in the enhanced response. Further, enhanced response builder 122 can utilize workflow intelligence integration steps in order to deterministically identify next steps and construct visualizations. These workflow intelligence integration steps can include nest path determination through graph traversal, node analysis for dependencies and conditions, and programmatic generation of mermaid diagrams. Finally, enhanced response builder 122 can perform protocol standardization steps for transforming node definitions into standardized protocols for execution, while any constraints, capabilities, and decision frameworks are explicitly mapped in enhanced response builder 122. Thus, enhanced response builder 122 can perform the transformation in a rules-based, deterministic approach that leverages well-defined data mapping procedures in place of AI-powered interpretation, in order to produce an enhanced JSON output for execution by LLM agent 102. Because enhanced response builder 122 operates through deterministic transformations and flattening, embodiments may reduce parsing ambiguity and memory churn. By extracting essential fields, normalizing structures, and flattening nested dictionaries into single-level objects, enhanced response builder 122 may reduce heap allocations during downstream parsing and prevent repeated coercion of heterogeneous shapes. Explicit mapping of constraints and capabilities may improve branch predictability and CPU cache utilization in consumers that process the machine-readable response.

During operation, enhanced response builder 122 can provide the machine-readable response to LLM agent 102 for execution of the detailed instructions and decision tree. LLM agent 102 can utilize a diagram processor 124 to natively understand and employ mermaid diagrams from workflow engine 106, enabling LLM agent 102 to reference possible paths and requirements for each path during execution of the workflow. LLM agent 102 can further utilize an action selector 126, such that LLM agent 102 can assess a current state of the workflow against the machine-readable response and determine and execute an ideal next step to accomplish the desired goal of the workflow.

In some embodiments, LLM agent 102 must return to workflow engine 106 for a further next step after each executed action. The enhanced JSON response provided to LLM agent 102 can directly provide a structured interaction loop for carrying out a workflow through the execution of a single step at a time. As such, workflow engine 106 can provide the enhanced JSON response which contains clear instructions, a specified API endpoint, a set of validation rules and examples, and a visualization of the possible next paths to be taken by LLM agent 102. LLM agent 102 can utilize the enhanced JSON response to execute only the current step for which the clear instructions are provided. Following this execution, LLM agent 102 can submit the completed step, along with any corresponding results and statuses, back to workflow engine 106. Workflow engine 106 can then process the success or failure of the step and determine new instructions for the next step to be taken in the workflow, which is returned to the LLM agent 102 as a new enhanced JSON response.

As such, system 100 can enable the autonomous determination of next steps, consequences, and constraints for a workflow using only a workflow name or identifier as an input. Through the use of workflow engine 106, system 100 can provide LLM agent 102 with structure instructions that can include an overall workflow visualization, global next steps to be taken in the workflow, node-specific decision options based on a current state, visual representations of each node's possible path, explicitly detailed AI agent prompts, and domain-specific insights for the desired workflow. Workflow engine 106 can enable the automatic execution of the workflow on target system 110 and through API modules 114 to perform the desired services related to identity management services.

Building on the structured, stepwise interaction loop described for system 100, embodiments may realize hardware-oriented efficiencies during next-step execution by constraining per-step inputs and outputs. Systems and methods provided herein address integration latency and compute overhead in enterprise environments by structuring agent execution around compact, self-describing task payloads constructed by workflow engine 106. By emitting only the next required action with an executable request template and success-criteria metadata, next path generator 118 and agent context manager 120 may improve data locality, constrain the working set to step-specific parameters, and reduce unnecessary state serialization. This zero-shot interaction loop may shorten central processing unit (CPU)-bound decision cycles for LLM agent 102, reduce transient memory allocations associated with broad context prompts, and curb interconnect load between components by limiting round trips to a single actionable step and measured result. In practice, deterministic transformations and node-scoped guidance may streamline data handling and lower system overhead during sequential execution, which may translate to lower energy use on shared compute platforms.

Referring now to FIG. 1B, a system 130 is an alternate embodiment for enabling agentic consumption of workflows for identity management systems with a zero-shot approach. System 130 similarly provides workflow engine 106 for receiving a workflow name or identifier from LLM agent 102, which can be received from a human operator 132. In the illustrated embodiments, workflow engine 106 includes a JSON triplet constructor 134 operable to construct the enhanced JSON response, or self-describing zero-shot task payload 136, which can bundle the explicit action required, the executable request template, and minimal role-oriented guidance or context (or success-criteria metadata, executable request template, and natural-language guidance). In the illustrated embodiment, workflow engine 106 can be in communication with a plurality of external data sources 138, which can provide API documentation or other pertinent parameters for executing the tasks. External data sources 138 can include a database 140, a cloud storage 142, and one or more network devices 144, each of which can be communicatively coupled to workflow engine 106 for provision of data.

The triplet of the required action, the request format, and the AI context can be dynamically rendered via JSON triplet constructor 134 at each wait-state of the workflow execution to enable a rules-based agent (e.g., LLM agent 102) to execute the task without pre-registration of schemas or any custom code. In some embodiments, the AI context section can include a SHA-256 checksum of the executable request template to detect tampering by downstream operators or agents. Self-describing zero-shot task payload 136 can further provide an automatic flattening of nested results such that only one result object exists to ensure deterministic parsing of the commands. Self-describing zero-shot task payload 136 can be constructed using safe, pluggable condition-evaluation operations to convert human-readable edge rules into machine-evaluated logic. In some embodiments, self-describing zero-shot task payload 136 can work along side next path generator 118 to enable previewing of parallel decision branches before committing the agent to a specified task. At each wait-state, triplet bundling may reduce execution surface and concentrate validation steps. JSON triplet constructor 134 may bind the required action, the executable request template, and minimal context into a compact object that LLM agent 102 can process without schema registration. A checksum of the request template in the context may enable early tamper detection, avoiding wasted compute on malformed payloads and reducing unnecessary I/O associated with rejected calls.

In these embodiments, next path generator 118 can receive and parse the triplet of the self-describing zero-shot task payload 136 and determine if the next step of the workflow is allowed. If the next step is allowable, the next path generator 118 can compute success criteria for the allowed next step and generate mermaid nodes that can represent the paths for the next step and path. Finally, next path generator 118 can itself construct a new triplet for a new self-describing zero-shot task payload (not shown), as well as a new mermaid diagram using the generated nodes, for use by the LLM agent 102. Next path generator 118 can further construct (or leverage mermaid diagram generator 116) the mermaid diagram as a dynamically-generated next path map and including node labels corresponding to discrete workflow steps. In some embodiments, next path generator 118 is operable to collapse the mermaid diagram into a single path for linear sequences, while expanding the mermaid diagram into a tree structure for workflows including conditional branches. In further embodiments, next path generator 118 or workflow engine 106 can include a field validation module operable to validate an action of the self-describing zero-shot task payload 136 against a registry of permitted operations prior to passing the self-describing, zero-shot task payload to the LLM agent. In further embodiments still, next path generator 118 or workflow engine 106 can include a preview module operable to render the self-describing, zero-shot task payload in an HTML representation for approval by human operator 132 prior to passing self-describing zero-shot task payload 136 to the LLM agent 102. Prior to dispatch, embodiments may validate actions locally and provide a preview to reduce avoidable retries. A field validation module and a human-approvable HTML preview may filter disallowed operations and type mismatches before connector calls are executed. Local rejection and correction may reduce outbound traffic to target system(s) 110, lower the number of failed transactions retried over the interconnect, and shorten operator cycles by catching errors at construction time.

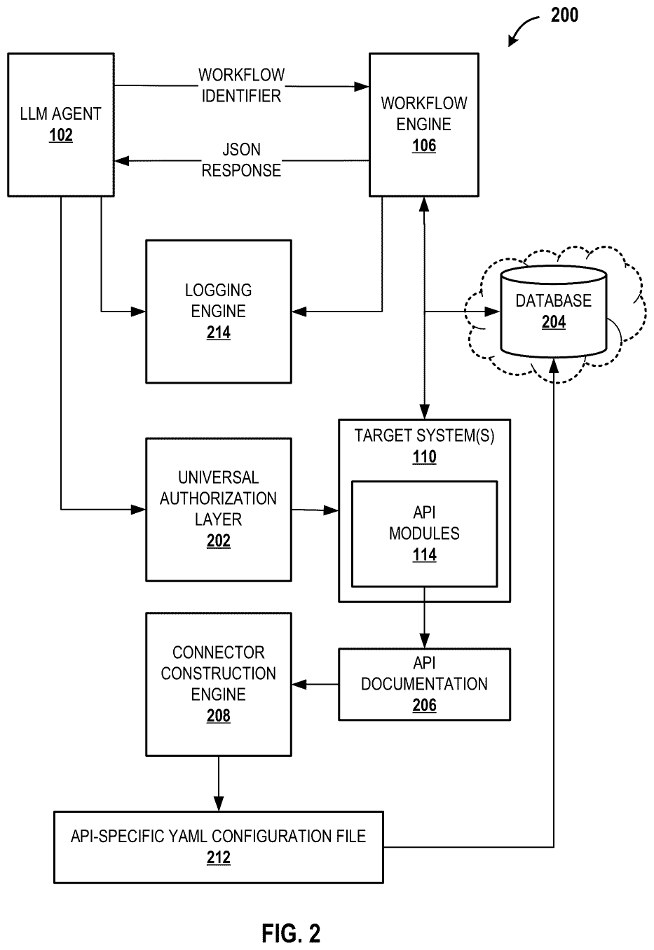

FIG. 2 is an example system 200 for autonomously adding new API-specific workflow capabilities for execution by LLM agent 102. System 200 can include LLM agent 102, workflow engine 106, and target system(s) 110, such that LLM agent 102 can perform the desired workflow on target system 110 in a zero-shot manner. System 200 can further include a universal authorization layer 202 operable to normalize access requests and enforce policies across multiple identity providers and policy decision points for target system(s) 110. System 200 can include a database 204 communicatively coupled with workflow engine 106 and target system 110, database 204 including a plurality of configuration files built for various APIs and workflows. To enable the integration of new API functionality for workflow engine 106, system 200 can include one or more pieces of API documentation 206 corresponding to API modules 114 of target system(s) 110, as well as a connector construction engine 208 operable to construct an API-specific YAML configuration file from API documentation 206. In some embodiments, LLM agent 102 and workflow engine 106 can be in communication with a logging engine 214 for recording all identity-related operations in a standardized audit format.

In operation, LLM agent 102 can provide a workflow name or identifier to workflow engine 106 in order to obtain a machine-readable JSON response for execution on LLM agent 102. In some embodiments, workflow engine 106 can detect, via an API endpoint, when LLM agent 102 is executing a workflow without prior context, and can provide the JSON response to LLM agent 102. In these embodiments, workflow engine 106 can communicate with target system 110 to identify the API modules 114 that are to be employed or targeted in the workflow. In some embodiments, workflow engine 106 can reference database 204, which can be locally-stored or cloud-operated, to receive an API-specific configuration file from corresponding to API modules 114. In these embodiments, an available configuration file can be provided to workflow engine 106 for construction of the JSON response, as discussed in FIG. 1A-B. In further embodiments, however, API modules 114 can represent new functionality to be added to database 204 and workflow engine 106. In these embodiments, system 200 can extract API documentation 206 corresponding to the desired API against which the workflow is to be executed.

API documentation 206 can include textual descriptions of possible operations as well as paths, constraints, and consequences for each operation. API documentation can be provided to connector construction engine 208 for the production of a new configuration file for the workflow and API to be added. Connector construction engine 208 can leverage a separate AI agent to receive API documentation 206, parse the textual descriptions throughout API documentation 206, and construct a new configuration file, such as API-specific YAML configuration file 212. Unlike LLM agent 102, the AI agent of connector construction engine 208 can be extensively trained to produce API-specific YAML configuration file 212 from input API documentation 206. Connector construction engine 208 can facilitate the extraction of API-specific information such as the instructions, success criteria, constraints, contexts, and next steps for a workflow found in API documentation 206, as well as the conversion of this information into a digestible YAML structure with endpoints, transforms, scopes, and other pertinent data. In some embodiments, API-specific YAML configuration file 212 can be open-ended regarding the identity management software to be targeted, such that the file includes a generalized fabric which any system can use, including various identity management systems, LLM agents, and other orchestration engines.

In some embodiments, connector construction engine 208 can utilize template-based command generation to transform static code found in API documentation 206 into dynamic, template-driven YAML configurations while maintaining version control and performing schema validation. In these embodiments, connector construction engine 208 can employ typed expression evaluation to differentiate between string outputs and other formats, dynamic rendering control to perform multi-pass rendering for complex transformations, and conditional command generation that can enable the use of extensive conditional statements in generating the configuration files. Further, connector construction engine 208 can include multi-protocol support to enable a variety of protocols (e.g., lightweight directory access protocol (LDAP), secure shell (SSH), REST) to be used in command generation through a single, unified configuration structure. In some embodiments, the use of parameterized commands to dynamically generate commands via specified templates and a response transformation pipeline to post-process raw responses into expressional-based syntax can further aid connector construction engine 208 in constructing API-specific YAML configuration file 212.

Connector construction engine 208 may support multi-format import and guided conversion to executable YAML connectors, accepting external specifications as OpenAPI 3.x, Swagger 2.0, or Postman collections received by URL, file upload, or pasted text. The engine may automatically detect the input format, extract metadata, perform verb-to-operation mapping, and present an interactive preview that allows operator overrides prior to registering the connector for runtime use. This workflow may consolidate conversion steps and may shorten execution time during onboarding of new APIs. During connector onboarding, guided conversion may consolidate import work into a single pass. Connector construction engine 208 may automatically detect OpenAPI, Swagger, or Postman inputs, extract metadata, and present a preview for operator overrides prior to registration. This guided flow may reduce iterative staging cycles, limit redundant reads across storage tiers when recompiling connectors, and shorten deployment time by enabling immediate runtime use without redeploying the system.

In some embodiments, API-specific YAML configuration file 212 can include a hierarchical structure with specific execution semantics for use in desired functions. Each API-specific YAML configuration file 212 (or any system-level configuration file) can include a header section for a name, version, connection, and other bibliographical information, as well as a commands map. The commands map can include a plurality of possible actions, with each entry of the commands map itself being a valid YAML fragment that can define a single executable action. Each of these actions, or command fragments, can describe a single protocol (e.g., HTTP REST method, SSH/telnet command, LDAP/open database connectivity query or procedure) supported by connector construction engine 208. Each command fragment can itself include declarative fields such as endpoint, method, body, transform, retry, or idempotent. These command fragments can be recursively compiled into a protocol-agnostic command object by connector construction engine 208 or enhanced response builder 122, which conforms to the platform of interest's canonical execution schema. In some embodiments, the command object can be invoked directly (e.g., via LLM agent 102) in a single API call for direct action. In further embodiments, however, the command object can be inserted into a workflow graph as a vertex, or action node, that can be managed by workflow engine 106 for a directed acyclic workflow. In these embodiments, any dependencies and parallelisms can be derived from topology of the workflow graph within workflow engine 106.

Following construction of API-specific YAML configuration file 212 via connector construction engine 208, the new API-specific YAML configuration file 212 can be provided to database 204 for future use. As such, database 204 can continue to compile a collection of YAML configuration files for use in workflow engine 106 to construct the machine-readable response that will enable LLM agent 102 to perform a workflow in a zero-shot manner. With API-specific YAML configuration file 212 included in database 204, workflow engine 106 can access API-specific YAML configuration file 212 to construct the JSON response to be returned to LLM agent 102. As LLM agent 102 executes the workflow using the JSON response, any actions, results, and success criteria can be logged in logging engine 214 to maintain an auditable record of automated actions taken. To perform the various actions of the workflow, LLM agent 102 can route communication through universal authorization layer 202 to provide vendor-agnostic normalization of requests and policies across multiple identity providers and policy decision points.

In at least one embodiment, logging engine 214 may emit structured request receipts for MCP operations and provide both recent and streaming access for audit purposes. Each receipt may include identifiers such as subject, tool, scopes, method, duration, outcome, and timestamp, with a bounded in-memory buffer retaining recent entries for inspection and an endpoint that exposes a live stream using server-sent events (SSE). In some embodiments, receipt listings may support conditional GET to avoid retransmission of unchanged data, which may reduce network traffic and lower power draw during monitoring. For audit and monitoring, incremental delivery may replace repeated full-payload polling. Streaming request receipts via server-sent events and retaining a bounded in-memory buffer may allow consumers to tail recent activity without re-fetching complete logs. Conditional responses for listings may further avoid retransmission of unchanged entries, which may curb interconnect load and reduce disk I/O associated with persistent log scans.

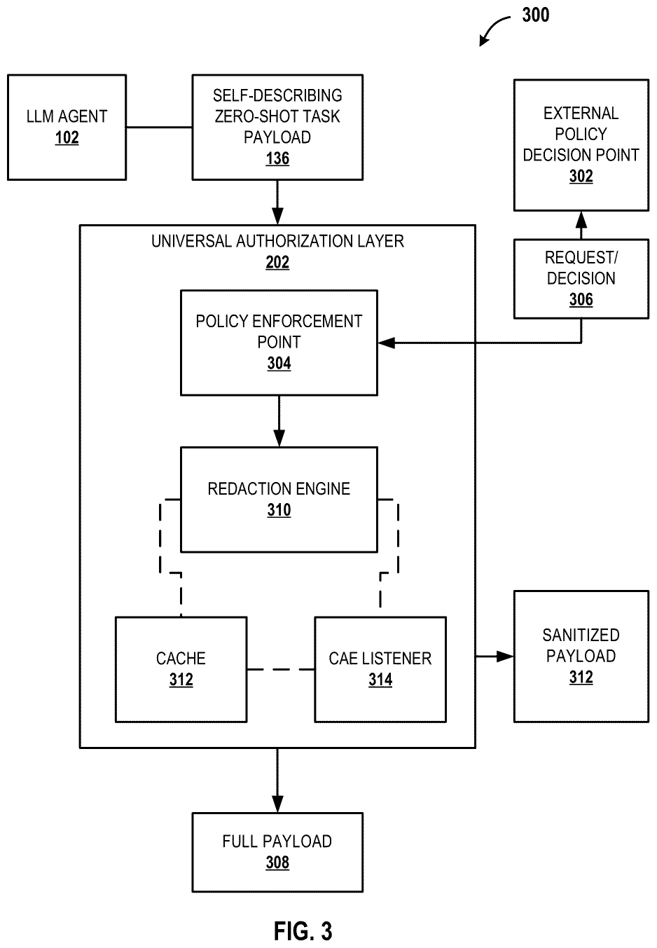

FIG. 3 is a schematic view of an authorization system 300 using universal authorization layer 202 for performing policy-aware execution of payloads, according to one or more embodiments of the present disclosure. Authorization system 300 can include universal authorization layer 202 for interfacing with an external policy decision point (PDP) 302. LLM agent 302 can provide self-describing zero-shot task payload 136 to universal authorization layer 202, which can leverage a policy enforcement point 304 to perform a request of external PDP 302. Policy enforcement point 304 can be a pluggable tool operable to communicate the pending self-describing zero-shot task payload 136 with the external policy-decision point 302 in the form of request/decision 306. Request/decision 306 can be passed to external PDP 302 as the pending payload, and external PDP 302 can return request/decision 306 as either an allowance or a denial. In the event of an allowance in request/decision 306, universal authorization layer 202 can output full payload 308 as an allowable self-describing zero-shot task payload 136 to be executed.

However, if request/decision 306 is returned as a denial of self-describing zero-shot task payload 136, universal authorization layer 202 can leverage a redaction engine 310 in communication with the pluggable policy enforcement point 304 to correct any unauthorized operations. Redaction engine 310 can utilize the denial of request/decision 306 to sanitize one or more unauthorized operations from self-describing zero-shot task payload 136 to construct a sanitized payload 312. The sanitization performed by redaction engine 310 can further include masking of disallowed data fields in sanitized payload 312 through the use of placeholder tokens. Once self-describing zero-shot task payload 136 has been converted into sanitized payload 312, policy enforcement point 304 can further communicate sanitized payload 312 to the external PDP 302 for a further request/decision 306. In some embodiments, universal authorization layer 202 and policy enforcement point 304 can include decision protocols compliant with multiple policy languages including, but not limited to, Open Policy Agent (Rego), Cedar, and AuthZen-compliant decision protocols. Further, universal authorization layer 202 can enable swapping of PDP vendors for external PDP 302 without redeployment, requiring only editing of YAML configuration files.

In some embodiments, universal authorization layer 202 can further include a cache 314 operable to store allowed decisions for a first time-to-live, or hop limit, and denied decisions for a second hop limit shorter than the first hop limit. In these embodiments, cache 314 can be a deterministic, attribute-based cache for storing active decisions during the enabled timeframe. Universal authorization layer 202 can further include a continuous-access-evaluation (CAE) listener 316 operable to ingest token-revoked CAE protocol events and purge corresponding entries in cache 314 within a pre-determined time limit, performing automatic cleanup. In some embodiments, the pre-determined time limit is about 30 seconds, such that CAE listener 316 can rapidly remove corresponding entries for toke-revoked users and requests. In some embodiments, cache 314 can further utilize a cryptographic hash of request/decision 306 as a cryptographic key for deterministic caching.

As such, the use of authorization system 300 can enable the delegation of authorization to any external PDP 302 at runtime, without the need for code changes or unique execution paths across APIs, workflow nodes, or command executors. Authorization system 300 can centralize these authorization calls while converting diverse REST routes into standardized policy attributes (e.g., system, object_type, action, resource_id) through YAML mappings. The deterministic caching of universal authorization layer 202, cache 314, and CAE listener 316 can reduce latency and costs from external PDP 302. Further, authorization system 300 can accordingly enable identity claim enrichment, such as adding roles, permissions, or groups, as well as context merging before sending a request within request/decision 306.

In view of the centralized policy enforcement and caching mechanisms of authorization system 300, embodiments thereof may further reduce avoidable network traffic and compute cycles associated with policy checks and denials. For example, the centralized policy enforcement and caching mechanisms of authorization system 300 may further mitigate authorization bottlenecks and redundant network traffic via an execution gateway that normalizes and enforces policies at universal authorization layer 202. A pluggable policy enforcement point 304 and redaction engine 310 may consolidate multiple external requests into a single allow or sanitized resubmit, reducing REST backhaul and avoiding full payload retries when disallowed fields are present. Attribute-based cache 314 and a continuous-access-evaluation listener 316 may reduce repeated policy decision calls, which can lower PDP-induced latency and I/O pressure under high concurrency. By masking disallowed attributes and revalidating locally, the gateway may reduce read-write activity on external services and may lower power draw by minimizing unnecessary cryptographic operations and network transmissions associated with denied actions.

### Aspects Related to a Template-based Connector Architecture

The present disclosure relates to a template-based connector architecture that may be configured as part of or in communication with any of systems 100-300. The template-based connector architecture may include a multi-pass rendering engine and a unified execution engine. This architecture may be configured or otherwise arranged to translate, by way of at least the multi-pass rendering engine and/or unified execution engine, various heterogeneous protocols (e.g., targeted protocols) of one or more identity management systems into a standardized JSON request/response surface, facilitating seamless integration and interaction across the one or more different systems. The multi-pass rendering engine may be electronically and/or communicatively coupled to the multi-pass rendering engine and may be configured or otherwise arranged to processes templates. Templates may include, for example, templates utilized at construction engine 208 of FIG. 2 to transform static code into the dynamic, template-driven YAML configurations discussed above with respect to FIGS. 1A-3.

In at least one embodiment, templates may be constructed by the multi-pass rendering engine by processing each targeted protocol in three distinct stages: secret-pass, expression evaluation, and type-validation. In the secret-pass stage, placeholders of each targeted protocol may resolved against a vaulted credential store (e.g., which may be a data store internal or external to the system, or some combination thereof). During the expression evaluation stage, typed Jinja-compatible expressions associated with the targeted protocols are evaluated. Finally, in the type-validation stage, runtime type-validation is performed using declarative schema definitions. Once each targeted protocol is processed and transformed by the multi-pass rendering engine, the unified execution engine translates the targeted protocols into a single JSON request/response surface and supports various adapters. Adapters may include, for example, LDAP, system for cross-domain identity management (SCIM), SSH, REST, open database connectivity (ODBC), and open data protocol (ODATA), through a common execute endpoint.

In at least one example, the unified execution engine may use typed YAML templates compatible with the multi-pass rendering schema and output to orchestrate actions across diverse protocols such as LDAP, REST, SCIM, and SSH through a single interface. This allows workflows to call different system types seamlessly via one declarative surface, with the engine handling the protocol specifics in multiple rendering passes if needed. The unification of identity protocols (e.g., LDAP and/or SCIM), APIs (e.g., REST), and shell protocols (e.g., SSH) under one template system may allow for streamlined management and integration across diverse systems.

Additionally, the architecture may include a schema-mapping engine that performs bidirectional transformations between remote-system schemas and an internal canonical model. Each rendered template may be cached under a secure hash algorithm (e.g., 256-bit (SHA-256) digest) of its post-render content, allowing identical templates to be executed only once per caching interval. Runtime validation errors are surfaced as structured JSON exceptions, containing both the failing field's path and the associated type rule violated.

The present disclosure may enhance orchestration platforms by integrating various connectors through a uniform configuration. It provides a protocol-agnostic engine that handles different systems in one flow. The use of typed templates with multiple passes manages interdependent values and iterative data fetching. Additionally, it allows users to connect disparate systems with no coding (e.g., YAML configuration), reducing integration time and errors. By supporting multiple protocols in one place, the present disclosure replaces several siloed tools with one unified solution.

Aspects of the present disclosure may also provide a hardware-oriented structure for the template-based connector architecture. This structure may include one or more CPUs that execute the multi-pass rendering engine and unified execution engine. The CPUs may be connected to a memory unit that stores the templates, schema definitions, and cached rendered templates. The memory unit may include both volatile memory, such random access memory (RAM), and non-volatile memory, such as solid-state drives (SSD) or hard disk drives (HDD). The architecture may further include a network interface card (NIC) that facilitates communication with external systems and protocols, such as LDAP, SCIM, SSH, REST, ODBC, and ODATA. The NIC may enable the architecture to send and receive data over a network, integrating with remote systems. Additionally, a secure hardware component, such as a trusted platform module (TPM), may manage and store vaulted credentials securely, performing secret-pass operations with high security. The hardware-oriented structure is designed to optimize the performance and reliability of the template-based connector architecture, providing a robust and scalable solution for enterprise integration and automation.

In at least one aspect, JSON may be a lightweight data interchange format that is easy for humans to read and write and easy for machines to parse and generate. It is based on a subset of the JavaScript programming language and is used to represent structured data. In some cases, JSON is may be used for transmitting data in web applications between a server and a client.

Expression evaluation may be the process of interpreting and executing expressions within a template to produce a final value. In the context of a multi-pass rendering engine, this stage involves evaluating typed expressions, such as Jinja-compatible expressions, to generate content based on the template's logic. This may facilitate customization and generation of template content.

Type-validation may be the process of checking that the data within a template conforms to predefined schema definitions. Type-validation helps to prevent errors and maintain data integrity by validating the data against a set of rules.

Jinja-compatible expressions may be a type of template expression that follows the syntax and rules of the Jinja templating engine. These expressions allow for dynamic content generation within templates by supporting logic, loops, and variable substitution. Jinja-compatible expressions may be used in web development and configuration management to create flexible and reusable templates.

A schema-mapping component may be a system that performs bidirectional transformations between external system schemas and an internal canonical model. It maps data structures from remote systems to a standardized internal format and vice versa.

Bidirectional transformations may refer to the process of converting data between two different schemas or formats in both directions. This means that data can be transformed from an external system's schema to an internal canonical model and back again.

YAML may be a human-readable data serialization format that is used for configuration files and data exchange between languages with different data structures. It is designed to be easy to read and write. YAML supports complex data structures, including mappings, sequences, and scalars.

Shell operations may refer to commands and scripts executed within a command-line interface (CLI) or shell environment. These operations can include file manipulation, process control, and system administration tasks.

### Aspects Related to a Model Context Protocol (MCP) Adapter

Additionally, the present disclosure relates to a dual-mode MCP adapter designed to function as both an MCP client and server. This adapter may facilitate the ingestion of remote MCP tools into local YAML configurations as part of or in communication with any of systems 100-300. This adapter may also facilitate the exposure of local workflows as MCP endpoints. The adapter may operate in both consumer and provider modes, negotiating token-binding and maintaining an on-behalf-of (OBO) parent-child token graph for agent accountability (e.g., agent accountability at LLM 102).

In consumer mode, the adapter may consume external MCP tools by generating local YAML connector definitions. In provider mode, it may expose internal commands or workflows as MCP endpoints, with each invocation secured under a user-bound-agent token. In either mode, the adapter may use a token-binding handshake for secure communication and maintain an OBO parent-child token graph for agent accountability. Additionally, it may include a token-revocation stream that may immediately terminate any active MCP session associated with a revoked user-bound-agent token.

Inbound MCP traffic may be transported (e.g., over WebSocket) and validated using a demonstration of proof-of-possession (DPoP)-bound access token. Outbound MCP calls may be executed using a unified execution engine (e.g., such as described above with respect to the template-based connector architecture), with results routed back to the calling agent over the same session (e.g., WebSocket session). The exposure of internal workflows as MCP endpoints may be configurable via a flag that enables or disables individual commands at runtime without redeployment.

The dual-mode operation of the adapter may support both consuming and providing MCP tools within a single platform. This positions the adapter as a universal integration layer that enables bi-directional interoperability with any MCP-enabled AI assistants or tools. The adapter's ability to act as a universal connector in an artificial intelligence (AI) integration network may allow for seamless integration of AI agents (e.g., LLM agent 102) with enterprise data and tools.

Given the dual-mode MCP adapter and the unified execution engine, the template-based connector architecture may yield compute and I/O gains when orchestrating across heterogeneous protocols. A template-based connector architecture with a multi-pass renderer and a unified execution engine may consolidate protocol handling into a single JSON surface, reducing adapter proliferation and context switching across heterogeneous stacks. Secret-pass resolution and typed expression evaluation may prevent late-binding failures, while caching of compiled templates under a digest of post-rendered content may remove repeat computation across identical calls, which can improve CPU cache utilization and reduce memory pressure. In concert, connector construction engine 208 may register executable YAML connectors for immediate use without redeploy, and the bidirectional MCP adapter may scope tool catalogs and endpoints to reduce catalog payload sizes and NIC traffic during discovery. These arrangements may curb interconnect load and I/O traffic during orchestration, which may shorten execution time for multi-protocol operations and improve overall energy efficiency on the underlying hardware.

The MCP adapter may support a “virtual views” capability in which view definitions are expressed in a YAML configuration including multi-dimensional filters (for example, source, provider, instance, system, object_type, action, name_prefix, tags_include, tags_exclude). The MCP adapter may expose view-scoped endpoints (for example, “/mcp/{view}/tools/list” and “/mcp/{view}/jsonrpc”) that isolate tool catalogs by applying the filters at request time, while a view index builder may load and validate path prefixes, construct an in-memory filter index, and support hot-reload of the configuration without a service restart. In some embodiments, a fallback view generator may synthesize views for common patterns, such as workflows or provider groupings, when a view is not explicitly defined. This arrangement may consolidate discovery operations for multi-tenant deployments and may reduce unnecessary tool enumeration across tenants. For multi-tenant discovery, server-side scoping may limit catalog volume at the source. Applying multi-dimensional filters at view-scoped endpoints may produce smaller tool catalogs tailored to the requesting context, which may reduce NIC traffic and client-side parsing time. Hot-reload of view definitions may avoid service restarts and prevent cold cache conditions, while fallback synthesis for common groupings may remove configuration round trips during initial access.

Automated onboarding of external MCP providers may be supported via endpoints exposed through REST API gateway 108, where a test endpoint validates connectivity and enumerates tools and an apply endpoint provisions configuration. The test endpoint may optionally perform OpenID Connect (OIDC) discovery to obtain a token endpoint from a well-known configuration. The apply endpoint may generate a system type entry and a system instance YAML with connection parameters, store credentials in a vault using pointer substitution, create a corresponding view entry for scoped discovery, and register the external provider in a service graph for dependency tracking. Cache invalidation may be performed to make an onboarded provider immediately available without redeploying the system, which may streamline data handling and lower system overhead during integration.

In at least one embodiment, the onboarding workflow may include catalog synchronization to a service graph in which discovered MCP tools are registered as child service capabilities with associated metadata, such as names, descriptions, and input schemas, and a parent-child relationship is established to an orchestration service. Registration may occur in a background task to avoid blocking the onboarding response, and cache invalidation may be performed to reflect new relationships immediately in discovery endpoints, which may shorten execution time during subsequent tool lookups. Following onboarding, asynchronous catalog synchronization may minimize blocking and preserve cache coherence. Registering discovered MCP tools as child service capabilities in a background task may prevent onboarding responses from stalling under graph updates. Targeted cache invalidation may expose new relationships immediately to discovery endpoints while avoiding full cache eviction, which may shorten subsequent lookups and reduce compute spikes under concurrent access.

In at least one embodiment, the MCP adapter may accept a direct filters object in the JSON-RPC tools/list parameters to enable client-driven scoping. When a request specifies both a view and direct filters, the adapter may merge the sets and apply precedence to the direct filters for overlapping keys, yielding the effective filter set used to construct the catalog. This approach may enable ad-hoc filtering without authoring new view configurations and may shorten execution time for exploratory queries. In at least one embodiment, the MCP adapter may include or utilize router tools that collapse multiple provider or instance variants behind a concept-level tool definition. At invocation time, the MCP adapter may resolve a concrete variant using discriminators, such as provider and instance, optionally constrained by any active view filters, remove the discriminators from the execution arguments, and dispatch the call to the resolved system tool. Grouping by a concept identifier may reduce catalog size while maintaining deterministic routing and may streamline data handling during selection. At request time, precedence-based filter merging and discriminator resolution may reduce variant enumeration and reconfiguration churn. Merging direct filters with view filters while prioritizing request-specified keys may avoid authoring new configurations for ad hoc queries and may limit cache churn in discovery. Router tools that select a single provider or instance variant based on discriminators may collapse multiple listings into one logical entry, which may reduce memory pressure in catalogs and shorten dispatch time to the resolved system tool.

The present disclosure also describes a hardware-oriented structure for the MCP adapter. The hardware configuration may include CPUs that executes the adapter's software components, a NIC for handling and network communications (e.g., WebSocket related communications), and one or more secure cryptographic processors for managing token-binding and encryption tasks. The structure may also feature dedicated memory for storing YAML configurations and token graphs, as well as a high-speed bus to facilitate rapid data transfer between components. This hardware-oriented structure allows the adapter to handle high volumes of MCP traffic efficiently and securely, providing robust performance in real-time applications.

MCP is a communication protocol standard designed to facilitate the interaction between AI systems and various tools or data sources by standardizing the exchange of contextual information. It allows AI agents to request and utilize external functionalities or data in a structured and interoperable manner, creating a unified framework for integrating diverse AI capabilities across different platforms. By providing a common language and set of rules for communication, MCP enables different AI systems to work together more effectively, enhancing their overall functionality and performance. This protocol supports operations such as data retrieval, command execution, and workflow integration.

MCP tools are external functionalities or services that can be accessed and utilized by AI agents through the Model Context Protocol. These tools can include data sources, computational services, or other AI-driven utilities that enhance the performance of AI systems. By leveraging MCP tools, AI agents can extend their capabilities beyond their native functions, accessing a wide range of external resources and services. This modular approach allows for greater flexibility and scalability in AI system design.

MCP endpoints are specific access points within a system that expose internal commands or workflows as services available to external AI agents via the MCP. These endpoints allow AI agents to invoke predefined operations or retrieve data, facilitating seamless interaction between different AI systems and tools. Each MCP endpoint is secured and managed to ensure reliable and controlled access.

Agent accountability refers to the mechanisms in place to track and verify the actions and interactions of AI agents within a system. This includes maintaining logs of agent activities, managing token-based authentication, and ensuring that agents operate within their authorized scope.

Token-binding handshake is a security process that involves the exchange of cryptographic proofs between a client and a server to establish a secure communication session. This process binds an access token to a specific client, ensuring that only the legitimate holder of the token can use it.

Universal integration layer is a middleware framework that enables seamless connectivity and interoperability between diverse systems, tools, and AI agents. It acts as a bridge, allowing different components to communicate and work together using standardized protocols and interfaces.

Bi-directional interoperability refers to the ability of a system to both consume external services and expose its own services to external entities in a seamless and standardized manner. This capability allows for two-way communication and interaction between different systems, enabling them to utilize each other's functionalities and data.

### Example Methods

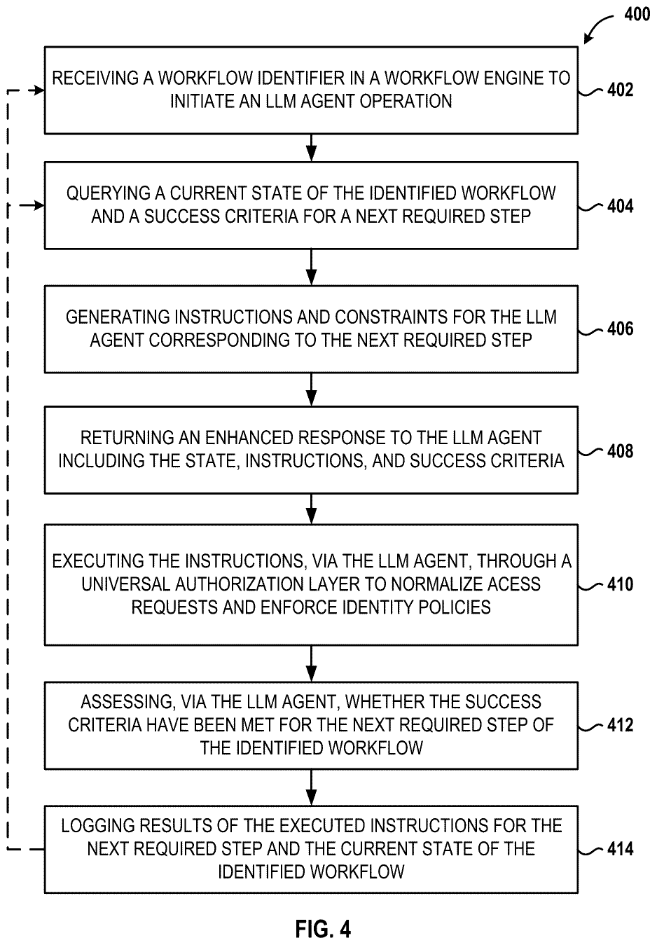

In view of the structural and functional features described above, example methods will be better appreciated with reference to FIGS. 4-6. While, for purposes of simplicity of explanation, the example methods of FIGS. 4-6 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 4 illustrates a method 400 for executing a workflow via an LLM agent in a zero-shot execution with only a workflow identifier as an input, according to one or more embodiments of the present disclosure. Method 400 can be implemented by systems 100, 200, and 300, as shown in FIGS. 1A-3. As such, reference may be made to the examples of FIGS. 1A-3 in the description of method 400. Method 400 can begin at 402 with receiving a workflow identifier in a workflow engine (e.g., workflow engine 106) to initiate operation of an LLM agent (e.g., LLM agent 102). The workflow identifier, or name, received at 402 can correspond with a CRUD service to be performed for a desired API or identity management solution, such as creating a user or updating credentials. Method 400 can thus begin with the receipt of only an identifier or name to identify the desired workflow at 402, such that no additional information or context is provided in the input. Using the workflow identifier, method 400 can continue at 404 with querying, via the workflow engine, a current state of the identified workflow, as well as a success criteria corresponding to the next necessary step of the workflow. The state of the identified workflow can be retained within workflow engine (e.g., via agent context manager 120), such that the history and status of each workflow is available for reference by and for LLM agents. In some embodiments, the next required step and success criteria can be identified via a next path generator (e.g., next path generator 118) to assess the workflow found on a corresponding configuration file (e.g., API-specific YAML configuration file 212) and extract the subsequent steps to be taken.

Method 400 can then continue at 406 with generating instructions and constraints for the LLM agent to perform the next required step identified at 404. In some embodiments, an enhanced response builder (e.g., enhanced response builder 122) can construct a machine-readable response to be used by the LLM agent to perform the next required step. In these embodiments, the machine-readable response can include all relevant constraints, validations, and steps to be taken, and each piece of information can be translated into an LLM agent-preferred format (e.g., a JSON response). Thus, method 400 can continue at 408 with returning the enhanced response to the LLM agent, with the response including each of the current state, the recommended instructions, and the criteria defining a successful operation. The enhanced response can enable the LLM agent to understand the workflow structure, constraints, logical paths, and desired results related to the identified workflow.

Method 400 can then continue at 410 with executing the instructions of the enhanced response to perform the desired workflow operations. In some embodiments, at 410, the LLM agent can perform the instructions through a universal authorization layer (e.g., universal authorization layer 202) in order to standardize any access requests while enforcing policies across multiple identity providers and policy decision points. As such, the LLM agent can execute the workflow in a vendor-agnostic manner, with the universal authorization layer providing any normalization for interfacing with a target system or identity service provider. At 412, and using the provided instructions, the LLM agent can assess the success of the next required step executed at 410. As the enhanced response included success criteria, the LLM agent can compare the result of the executed step against the proposed criteria to determine whether to proceed with further instructions or report a successful operation.

Regardless of the success or failure of the executed workflow at 410, method 400 can continue at 414 with logging the results of the executed instructions and the current state of the workflow. In some embodiments, a logging engine (e.g., logging engine 214) can write the results and state of the workflow in an auditable format, and can further provide the state of the workflow to the agent context manager for maintaining a state of the workflow in the workflow engine for further reference. Depending upon the success or failure of the workflow at 412, method 400 can return to 402 with the receipt of a further workflow identifier or name. In some embodiments, however, method 400 can return to 404 with querying a current state and identifying the next step and success criteria. In these embodiments, the LLM agent can continue to cyclically execute, or receive instructions from the workflow engine, without further input to accomplish the task of the identified workflow while assessing and logging results between each executed step.

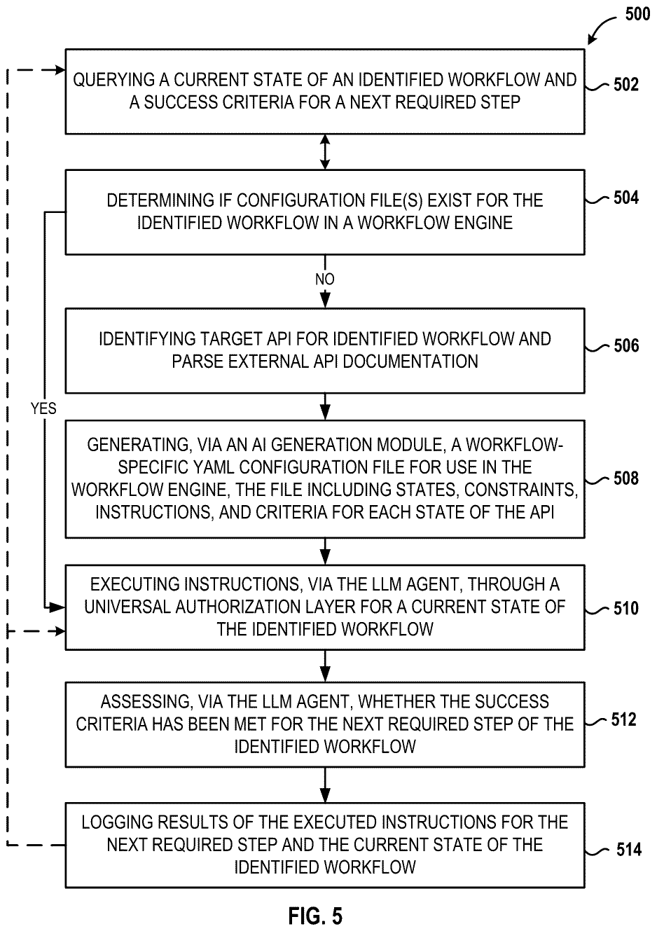

FIG. 5 is an example method 500 for executing a workflow for a process without a pre-constructed configuration file in a zero-shot manner, according to one or more embodiments of the present disclosure. Method 500 can be implemented by systems 100, 200, and 300, as shown in FIGS. 1A-3. As such, reference may be made to the examples of FIGS. 1A-3 in the description of method 500. Method 500 can begin at 502 with querying, via the workflow engine, a current state of the identified workflow, as well as a success criteria corresponding to the next necessary step of the workflow. The state of the identified workflow can be retained within workflow engine (e.g., via agent context manager 120), such that the history and status of each workflow is available for reference by and for LLM agents. In some embodiments, the next required step and success criteria can be identified via a next path generator (e.g., next path generator 118) to assess the workflow found on a corresponding configuration file (e.g., API-specific YAML configuration file 212) and extract the subsequent steps to be taken.

If, during the initial querying at 502, an error occurs regarding the possible next required step, method 500 can continue at 504 with determining if a configuration file exists for the identified workflow. At 504, a connected database (e.g., database 204) or memory of the workflow engine itself can be queried to identify the available configuration file, or lack thereof. If no configuration file is found or identified at 504, method 500 can continue at 506 with identifying a target API for the identified workflow. The identified workflow can correlate with the target API (e.g., API module(s) 114) through which the desired CRUD service can be performed, and external API documentation (e.g., API documentation 206) can be sourced for the target API. Further, at 506, the API documentation can be parsed to extract the textual descriptions and code structures for the target API.

Method 500 can continue at 508 with generating, via an AI generation module (e.g., connector construction engine 208), the workflow/API-specific configuration file to be used by the workflow engine to instruct the LLM agent. The configuration file can include each of the states, constraints, instructions, and criteria for each state of operations of the API, such that any scenario and operation can be undertaken. In some embodiments, the configuration file is a YAML file presenting the previously-discussed information in a plain text format, such that both humans and AI agents can read and edit the file. In further embodiments, however, the configuration file can be of any configuration file type, without departing from the scope of the present disclosure. In the disclosed embodiment, the configuration file can be passed through the workflow engine to generate a machine-readable response for the LLM agent to perform the desired next step of the workflow.

Method 500 can continue at 510 with executing the instructions, via the LLM agent, to perform the desired operation based upon a current state of the identified workflow. In embodiments in which the configuration files were pre-existing at 504, method 500 can continue at 510 directly from 504 without using the connector construction engine. Regardless of the initial existence of the configuration file, method 500 can continue with performance the desired workflow tasks at 510, while further passing the executed commands through a universal authentication layer to maintain the vendor-agnostic nature of method 500.

At 512, and using the provided instructions, the LLM agent can assess the success of the next required step executed at 510. As the enhanced response included success criteria, the LLM agent can compare the result of the executed step against the proposed criteria to determine whether to proceed with further instructions or report a successful operation. Regardless of the success or failure of the executed workflow at 510, method 500 can continue at 514 with logging the results of the executed instructions and the current state of the workflow. In some embodiments, a logging engine (e.g., logging engine 214) can write the results and state of the workflow in an auditable format, and can further provide the state of the workflow to the agent context manager for maintaining a state of the workflow in the workflow engine for further reference. Depending upon the success or failure of the workflow at 512, method 500 can return to 502 with querying a current state and identifying the next step and success criteria. As such, the next step in the workflow can be identified at 502, and cyclical performance of method 500 can continue as the workflow is executed. In some embodiments, however, method 500 can return to 510 with executing further instructions of the decision tree included in the original instructions, such that complex workflows can be carried out without further input or assessment, such as in the case of failure at 512. Thus, the LLM agent can continue to cyclically execute, or receive instructions from the workflow engine, without further input to accomplish the task of the identified workflow while assessing and logging results between each executed step.

In some embodiments, the generation at 508 can include one or more substeps of receiving external interface metadata for the target API, parsing the external interface metadata in an AI-based construction engine to extract instructions, constraints, states, and success criteria for a workflow, generating, via the AI-based construction engine, an executable YAML connector including definitions and associated workflow nodes using the instructions, constraints, states, and success criteria, and registering the executable YAML connector for immediate runtime use without re-deploying the system. In these embodiments, the executable YAML connector can include verb-to-operation mappings for each path item of the associated workflow nodes (e.g., for an OpenAPI specification). The external interface metadata received at 506 or 508 can include MCP tool descriptors, and the executable YAML connector can include a bi-directional schema for mapping parameters to a provider model and responses to a canonical model through a single schema. In some embodiments, generating the executable YAML connector at 508 can further include performing an error-correction loop that includes initiating a dry-run call against a staging endpoint and amending the executable YAML connector in response to a failed call. In further embodiments, the generation at 508 can further include receiving a user override, via an interactive wizard, for amending default-type mappings of the executable YAML connector while generating the executable YAML connector.

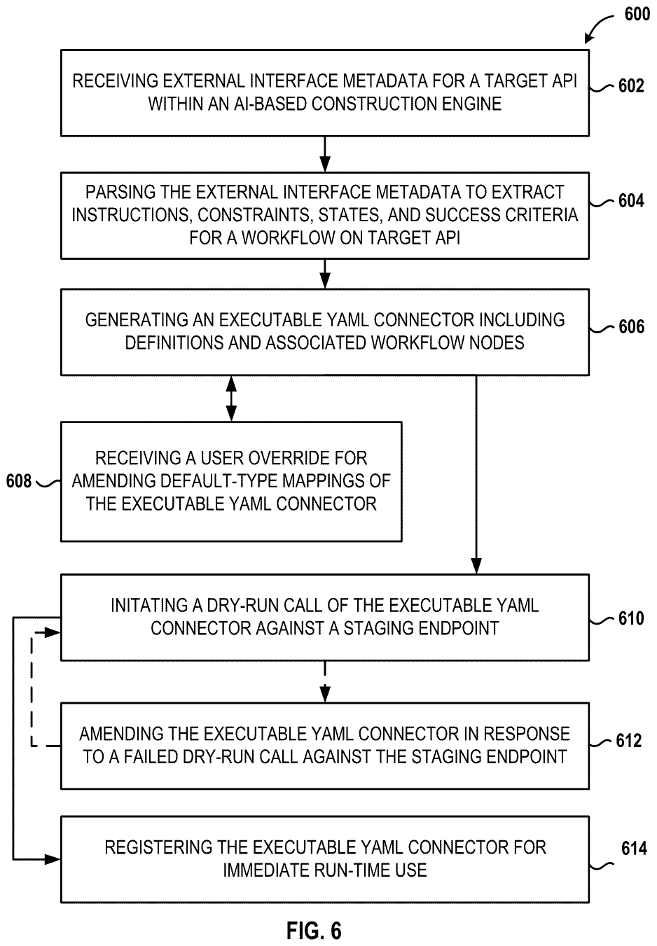

FIG. 6 illustrates a method 600 for constructing an executable YAML connector from external API documentation, according to one or more embodiments of the present disclosure. Method 600 can be implemented by systems 100, 200, and 300, as shown in FIGS. 1A-3. As such, reference may be made to the examples of FIGS. 1A-3 in the description of method 600. Method 600 can begin at 602 with receiving external interface metadata for the target API. In some embodiments, the external interface metadata can be directly retrieved from the target API or from documentation related to the target API (e.g., API documentation 206). The external interface metadata can provide all possible actions, states, and constraints to be performed on the target API.

As such, method 600 can continue at 604 with parsing the external interface metadata, in an AI-based construction engine (e.g., connector construction engine 208), to extract instructions, constraints, states, and success criteria for a workflow. The AI-based construction engine can be trained on previous external interface metadata to produce the desired executable YAML connector. Thus, the parsing at 604 can be guided by a trained AI or machine learning model operable to convert the external interface metadata into component parts to be inserted into an executable YAML connectors. In some embodiments, the external interface metadata can include MCP tool descriptors for simplified interfacing with various AI and API tools.

Method 600 can continue at 606 with generating, via the AI-based construction engine, an executable YAML connector including definitions and associated workflow nodes using the instructions, constraints, states, and success criteria. The executable YAML connector can be used via a workflow engine (e.g., workflow engine 106) to construct a self-describing zero-shot task payload (e.g., self-describing zero-shot task payload 136) for performing workflow tasks on the target API. In some embodiments, the executable YAML connector can include verb-to-operation mappings (e.g., for OpenAPI external interface metadata) for each path item of the associated workflow nodes, such that the workflow actions are easily convertible to machine-readable operations. In further embodiments, the executable YAML connector can include a bi-directional schema for mapping parameters to a provider model and responses to a canonical model through a single schema. In these embodiments, the bi-directional schema can automatically perform transforms or translations between the schema of the target API and the model of the CRUD service, with the same bi-directional schema governing both directions of translation.

During or after construction of the initial executable YAML connector at 606, method 600 can further include receiving a user override at 608 for amending default-type mappings of the executable YAML connector. While the AI-based construction engine can autonomously perform the parsing and construction of the executable YAML connector, advanced users/operators can fine tune and control the construction through user overrides. In some embodiments, the user overrides can be input through an interactive wizard operable to receive user inputs and amend the operations of the AI-based construction engine. As such, a user can amend any default mappings for the executable YAML connector in order to modify the functionality, constraints, or success conditions of each step in a workflow.

Following the initial construction of the executable YAML connector, method 600 can continue at 610 with initiating a dry-run call of the executable YAML connector against a staging endpoint. The dry-run call of the executable YAML connector can enable a test of the functionality of the YAML connector, as well as any failures in the permissions, structure, or constraints of each workflow call. After the dry-run call, if the staging endpoint returned a failure for the test, method 600 can continue at 612 with amending the executable YAML connector in response to the failed call. The executable YAML connector can be automatically amended via AI-based construction engine, or directly via user input, to correct the failure resulting from the dry run. As such, the combination of 610 and 612 can represent the performance of an error-correction loop in the construction of the executable YAML connector to ensure that any finalized, output YAML connector will run without errors. As such, method 600 can conclude at 614 with registering the executable YAML connector for immediate runtime use without re-deploying the system. The executable YAML connector can be registered in connected storage (e.g., database 204) for use in future, or current, API calls and workflows, such that the functionality of the new executable YAML connector can be rapidly loaded into the system and employed in real-time.

### Example Implementations

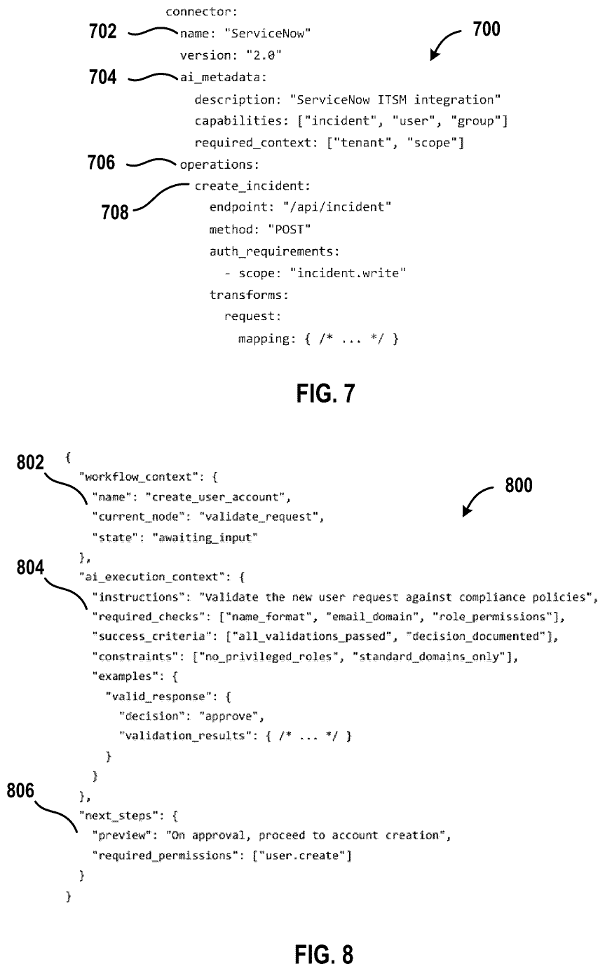

FIG. 7 is a sample connector 700 for an example of API-specific YAML configuration file 212, according to one or more embodiments of the present disclosure. Sample connector 700 includes a general name 702 for the service to which connector 700 is to facilitate connection. In the illustrated embodiment, name 702 denotes that connector 700 is for a SERVICENOW® software component. Connector 700 can further include any AI metadata 704 to be further provided to workflow engine 106 of FIGS. 1-2, including a description of connector 700, any capabilities included therein, and any context required to utilize connector 700. Further, connector 700 can include a listing of any possible operations 706 that can be performed in the specific API. As an example, connector 700 includes a “create_incident” operation 708, which itself includes the endpoints of the API, the method to be performed (e.g., HTTP POST method), any authorization requirements to be met by an identity management system, and any transforms to be applied. While sample connector 700 displays a single operation 708, listing of possible operations 706 can include any number of operations that can be performed on the target API, without departing from the scope of this disclosure. Sample connector 700 can be constructed via connector construction engine 208 of FIG. 2, such that sample connector 700 is the distilled and parsed version of a corresponding API documentation for the target API.

FIG. 8 is a sample machine-readable response 800 to be used by an LLM agent in executing an identified workflow, according to one or more embodiments of the present disclosure. Machine-readable response 800 is presented in a JSON format, which is to be received by the LLM agent in response to a provided workflow identifier. Machine-readable response can include workflow context 802, which can be provided by agent context manager 120 of FIG. 1A, to provide the workflow identifier, the current active node of the workflow, and the current state of the workflow at the active node. The LLM agent can utilize the workflow context 802 to serve as a persistent memory of prior results, as well as to verify that the active node and current state match the desired operations. Machine-readable response 800 can further include AI execution context 804, provided, for example, by enhanced response builder 122 of FIG. 1A. AI execution context 804 can include all of the instructions, required checks, success criteria, constraints, and examples (such as valid responses), that LLM agent 102 of FIGS. 1A-2 can use to execute the desired workflow. Further, machine-readable response 800 can include prescribed next steps for the desired workflow, such that the LLM agent can identify the overall workflow path and the next step or node that will continue the workflow. Machine-readable response 800 can provide all necessary information for an LLM agent to perform the desired workflow successfully, under the prescribed constraints, and in a zero-shot manner.

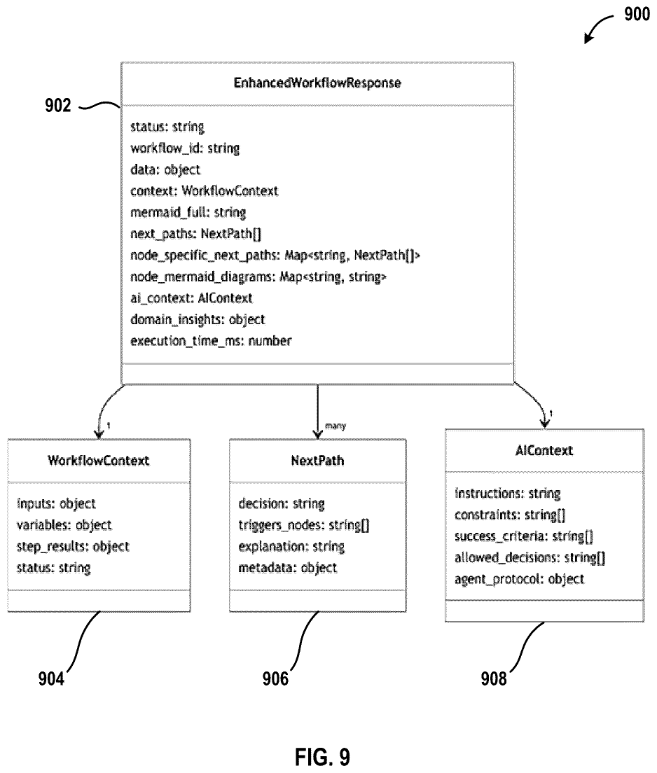

FIG. 9 is an example mermaid diagram 900 of the construction of a machine-readable response for executing an input workflow, according to one or more embodiments of the present disclosure. Mermaid diagram 900, as illustrated, is represented with the enhanced response 902 being formed of components parts: workflow context 904, next path information 906, and AI context 908. As discussed previously, enhanced response 902 can include all of the statuses, context, diagrams, instructions, and logging information for the desired workflow, which can be provided to an LLM agent for execution. As part of enhanced response 902, workflow context 904 can be provided by agent context manager 120 of FIG. 1A, for example. Workflow context 904 can include a variety of inputs, variables, and step results as objects which can be provided to enhanced response builder 122 of FIG. 1A, as well as a status of the workflow as a string, for constructing enhanced response 902. Similarly, AI context 908 can be provided by agent context manager 120 of FIG. 1A, and can include a plurality of strings defining instructions, constraints, success criteria, and allowed decisions, as well as an object defining the agent protocol to be followed. Enhanced response 902 can further include next path information 906, which can comprise a plurality of various next paths, each including strings to define possible decisions, triggering nodes, and explanations of the path to follow, as well as objects defining any pertinent metadata for each next path. Through the combination of these data sources 904-908, enhanced response 902 can be constructed to include all pertinent information about the workflow, the LLM agent, the histories of both, and the possible next steps that can be taken moving forward with the identified workflow.

### Example Computer System

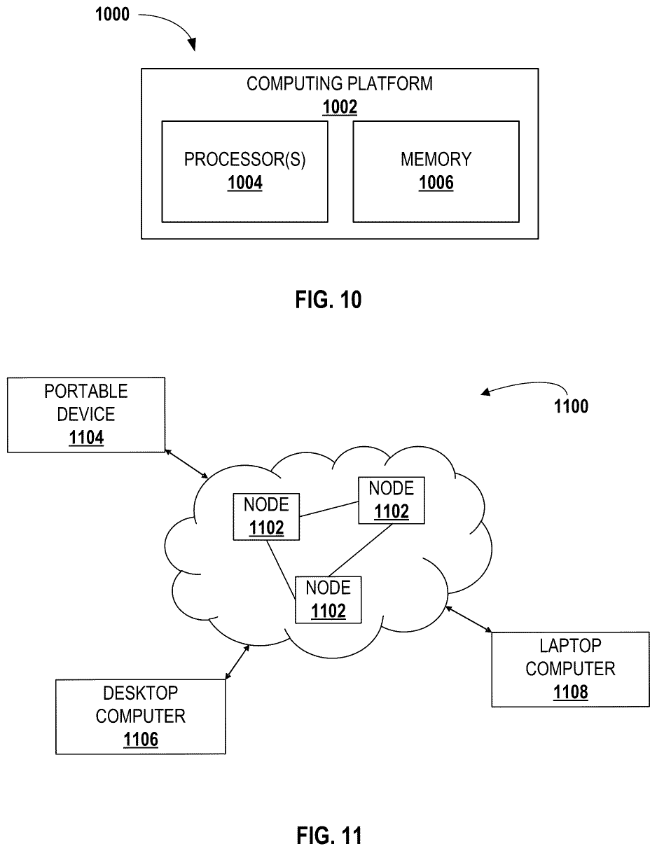

FIG. 10 is an example of a block diagram of a system 1000. System 1000 can be implemented using one or more modules, shown in block form in the drawings. The one or more modules can be in software or hardware form, or a combination thereof. In some examples, System 1000 can be implemented as machine readable instructions for execution on one or more computing platforms 1002 (referred to as a computing platform herein), as shown in FIG. 10. The computing platform 1002 can include one or more computing devices selected from, for example, a desktop computer, a server, a controller, a blade, a mobile phone, a tablet, a laptop, a personal digital assistant (PDA), and the like.

The computing platform 1002 can include a processor 1004 and a memory 1006. By way of example, the memory 1006 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 1004 can be implemented, for example, as one or more processor cores. The memory 1006 can store machine-readable instructions that can be retrieved and executed by the processor 1004 to implement system 1000. Each of the processor 1004 and the memory 1006 can be implemented on a similar or a different computing platform. The computing platform 1002 can be implemented in a cloud computing environment (for example, as disclosed herein) and thus on a cloud infrastructure. In such a situation, features of the computing platform 1002 can be representative of a single instance of hardware or multiple instances of hardware executing across the multiple of instances (e.g., distributed) of hardware (e.g., computers, routers, memory, processors, or a combination thereof). Alternatively, the computing platform 1002 can be implemented on a single dedicated server or workstation.

Cloud computing is a model of service delivery for enabling convenient, on-demand net-work access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service orient-ed with a focus on statelessness, low coupling, modularity, and semantic interoperability.

FIG. 11 is an example of a cloud computing environment 1100 that can be used for implementing one or more modules and/or systems in accordance with one or more examples, as disclosed herein. Thus, reference can be made to one or more examples of FIGS. 1-10 in the example of FIG. 11. As shown, cloud computing environment 1100 can include one or more cloud computing nodes 1102 with which local computing devices used by cloud consumers (or users), such as, for example, personal digital assistant (PDA), cellular, or portable device 1104, a desktop computer 1106, and/or a laptop computer 1108, can communicate. The computing nodes 1102 can communicate with one another. In some examples, the computing nodes 1102 can be grouped (not shown) physically or virtually, in one or more networks, such as Private, Community, Public, or Hybrid clouds, or a combination thereof. This allows the cloud computing environment 1100 to offer infrastructure, platforms and/or software as services for which a cloud consumer does not need to maintain resources on a local computing device. The devices 1104-1108, as shown in FIG. 11, are intended to be illustrative and that computing nodes 1102 and cloud computing environment 1100 can communicate with any type of computerized device over any type of network and/or network addressable connection (e.g., using a web browser). In some examples, the one or more computing nodes 1102 are used for implementing one or more examples disclosed herein relating to identity management services and workflows. Thus, in some examples, the one or more computing nodes can be used to implement modules, platforms, and/or systems, as disclosed herein.

In some examples, the cloud computing environment 1100 can provide one or more functional abstraction layers. It is to be understood that the cloud computing environment 1100 need not provide all of the one or more functional abstraction layers (and corresponding functions and/or components), as disclosed herein. For example, the cloud computing environment 1100 can provide a hardware and software layer that can include hardware and software com-ponents. Examples of hardware components include: mainframes; RISC (Reduced Instruction Set Computer) architecture based servers; servers; blade servers; storage devices; and networks and networking components. In some embodiments, software components include network ap-plication server software and database software.

In some examples, the cloud computing environment 1100 can provide a virtualization layer that provides an abstraction layer from which the following examples of virtual entities can be pro-vided: virtual servers; virtual storage; virtual networks, including virtual private networks; virtual applications and operating systems; and virtual clients. In some examples, the cloud computing environment 1100 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1100, and billing or invoicing for consumption of these resources. In one example, these re-sources can include application software licenses. Security provides identity verification for cloud consumers and tasks, as well as protection for data and other resources. The management layer can also provide a user portal that provides access to the cloud computing environment 1100 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing re-sources for which a future requirement is anticipated in accordance with an SLA.

### Example System

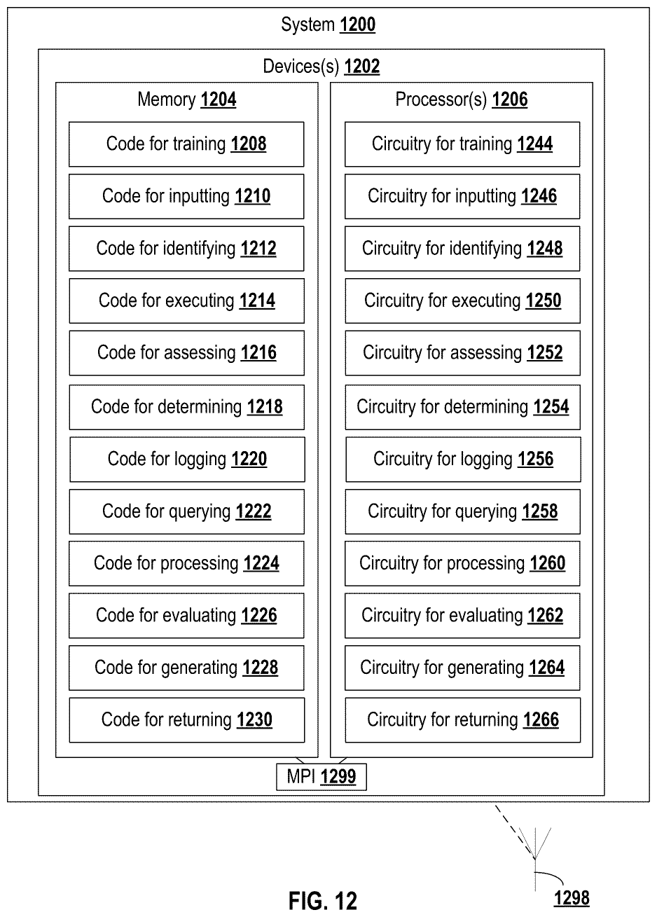

FIG. 12 illustrates a schematic diagram of an example system 1200. The system 1200 can be implemented as part of the utilization of a zero-shot AI workflow engine with LLM agents through a universal API gateway for autonomous execution of identity management system services, described with respect to FIGS. 1-8. Components of the system can be implemented at a single location or at multiple locations and can be a supervisory system or can be in communication with a supervisory system by way of a communication line. In at least one embodiment, the communication line can be a wireless communication line, a wired communication line, or both, though other types of communication line are contemplated.

The device(s) 1202 can include a CPU processing system, which can be configured to perform regularization procedures, such as those described herein with respect to FIG. 1A-8, as performed by the system 1200. The CPU processing system of the device(s) 1202 can include one or more processors 1206 coupled to a computer readable medium/memory 1204, for example via a bus (not shown). The one or more processors 1206 and the computer readable medium/memory 1204 can communicate via a message passing interface (MPI) 1299. In certain aspects the computer readable medium/memory 1204 is configured to store instructions (e.g., computer executable code) that when executed by the one or more processors 1206, cause the one or more processors to perform the methods 400, 500, or 600 described with respect to FIGS. 4-6, or any aspect related to it. Reference to a single processor performing a function of system 1200 can include one or more processors performing that function of system 1200.

In the depicted example, computer-readable medium/memory 1204 stores code (e.g., executable instructions) 1208 for training, code 1210 for inputting, code 1212 for identifying, code 1214 for executing, code 1216 for assessing, code 1218 for determining, code 1220 for logging, code 1222 for querying, code 1224 for processing, code 1226 for evaluating, code 1228 for generating, and code 1230 for returning. Processing of code 1208-1230 can cause the system 1200 to perform the methods 300 or 400 described with respect to FIGS. 3-4, or any aspect related to it.

The one or more processors 1206 include circuitry configured to implement (e.g., execute) the code stored in the computer-readable medium/memory 1204, including circuitry 1244 for training, circuitry 1246 for inputting, circuitry 1248 for identifying, circuitry 1250 for executing, circuitry 1252 for assessing, circuitry 1254 for determining, circuitry 1256 for logging, circuitry 1258 for querying, circuitry 1260 for processing, circuitry 1262 for evaluating, circuitry 1264 for generating, and circuitry 1266 for returning. Processing with circuitry 1244-1266 can cause the system 1200 to perform the methods 400, 500, or 600 described with respect to FIGS. 4-6, or any aspect related to it.

Various components of the system 1200 can provide means for performing the methods 400-600 described with respect to FIGS. 4-6, or any aspect related to it.

The system 1200 can include or be substantially coupled to a communication component 1298. In the depicted example, the communication component 1298 is an antenna capable of communicating with controllers similar to system 1200 to perform the methods 400 or 500 described with respect to FIGS. 4-6, or any aspect related to it. In additional examples, the communication component 1298 can be a bus or a wired connection.

In further embodiments, processing can be distributed among one or more processors at the same or different locations over a network. Processing steps 402-412 in method 400, processing steps 502-514 in method 500, system 100 and its components (LLM agent 102, natural language processor 104, workflow engine 106, mermaid diagram generator 116, next path generator 118, agent context manager 120, enhanced response builder 122, diagram processor 124, and action selector 126), and system 200 and its components (universal authorization layer 202, connector construction engine 208, and logging engine 214) can be implemented on any type of computing device including, but not limited to, a laptop, desktop, tablet, workstation, mobile device or smartphone, kiosk, embedded system, or other computing device having at least one processor and a non-transitory computable readable memory. The computing device can include a browser, application, and operating system along with a user-interface depending upon a desired configuration. The computing device can have functionality performed at the same or different physical locations and by one or more processors located at the same or different locations. A computing device can also be coupled to one or more application programming interfaces (APIs) to perform or distribute aspects of the functionality described herein. Computing functionality as described herein can also be implemented on a server, cluster of servers, web server, cloud-computing platform, and/or other remote service. A client/server architecture can also be implemented as would be apparent to a person skilled in the art given this description.

### Example Aspects

Implementation examples are described in the following numbered aspects:

Aspect 1: An agent-centric workflow system, including: a workflow engine operable to receive a workflow identifier and return a self-describing, zero-shot task payload, the workflow engine including: a next path generator operable to identify a possible next step in an identified workflow, dependencies between nodes of the identified workflow, and a consequence of the possible next step in order to construct a dynamically-generated next path map, and an agent context manager operable to construct the self-describing, zero-shot task payload including an executable request template, natural-language guidance, and success-criteria metadata for the possible next step; and a large language model (LLM) agent including a natural language processor and operable to receive a machine-readable response and execute the self-describing, zero-shot task payload in a zero-shot execution.

Aspect 2: The agent-centric workflow system of aspect 1, wherein the next path generator constructs the dynamically-generated next path map as a mermaid-compatible graph including node labels corresponding to discrete workflow steps.

Aspect 3: The agent-centric workflow system of aspect 2, wherein the next path generator is operable to collapse the mermaid-compatible graph to a single path for linear sequences and operable to expand the mermaid-compatible graph into a tree structure to include conditional branches.

Aspect 4: The agent-centric workflow system of any one of aspects 1 through 3, wherein the workflow engine further includes: a field validation module operable to validate an action of the self-describing, zero-shot task payload against a registry of permitted operations prior to passing the self-describing, zero-shot task payload to the LLM agent.

Aspect 5: The agent-centric workflow system of any one of aspects 1 through 4, wherein the self-describing, zero-shot task payload includes an artificial intelligence (AI) context section, the AI context section including a secure hash algorithm 256-bit (SHA-256) checksum of the executable request template to detect tampering by downstream operators.

Aspect 6: The agent-centric workflow system of any one of aspects 1 through 5, wherein the workflow engine further includes: a preview module operable to render the self-describing, zero-shot task payload in a hypertext markup language (HTML) representation for operator approval prior to passing the self-describing, zero-shot task payload to the LLM agent.

Aspect 7: An execution gateway for identity management systems, including: a pluggable policy enforcement point operable to communicate a pending task payload with and receive a denial decision from an external policy-decision point; and a redaction engine in communication with the pluggable policy enforcement point, the redaction engine operable to utilize the denial decision to sanitize one or more unauthorized operations from the pending task payload to construct a sanitized payload, wherein the pluggable policy enforcement point further communicates the sanitized payload to the external policy-decision point for a further request.

Aspect 8: The execution gateway of aspect 7, wherein the pluggable policy enforcement point includes decision protocols compliant with multiple policy languages.

Aspect 9: The execution gateway of any one of aspects 7 through 8, further including: a deterministic attribute-based cache operable to store allowed decisions for a first hop limit and denied decisions for a second hop limit shorter than the first hop limit.

Aspect 10: The execution gateway of any one of aspects 7 through 9, wherein the redaction engine further performs sanitization via masking of disallowed data fields using a placeholder token.

Aspect 11: The execution gateway of any one of aspects 7 through 10, further including: a continuous-access-evaluation (CAE) listener operable to ingest token-revoked CAE protocol events and purge corresponding cache entries within a pre-determined time limit.

Aspect 12: The execution gateway of aspect 11, wherein the pre-determined time limit is about 30 seconds.

Aspect 13: A computer-implemented method for constructing a connector for a target application programming interface (API), including: receiving external interface metadata for the target API; parsing the external interface metadata in an artificial intelligence-based (AI-based) construction engine to extract instructions, constraints, states, and success criteria for a workflow; generating, via the AI-based construction engine, an executable YAML connector including definitions and associated workflow nodes using the instructions, the constraints, the states, and the success criteria; and registering the executable YAML connector for immediate runtime use without re-deploying the system.

Aspect 14: The computer-implemented method of aspect 13, wherein the executable YAML connector includes verb-to-operation mappings for each path item of the associated workflow nodes.

Aspect 15: The computer-implemented method of any one of aspects 13 through 14, wherein the external interface metadata includes MCP tool descriptors and wherein the executable YAML connector includes a bi-directional schema for mapping parameters to a provider model and responses to a canonical model through a single schema.

Aspect 16: The computer-implemented method of any one of aspects 13 through 15, wherein generating the executable YAML connector further includes: performing an error-correction loop that includes initiating a dry-run call against a staging endpoint and amending the executable YAML connector in response to a failed call.

Aspect 17: The computer-implemented method of any one of aspects 13 through 16, further including: receiving a user override, via an interactive wizard, for amending default-type mappings of the executable YAML connector while generating the executable YAML connector.

Aspect 18: A template-based connector architecture, including: a multi-pass renderer for receiving a YAML connector and rendering strings, dictionaries, and lists of the YAML connector recursively while validating types, substituting secrets, and caching compiled templates; and a unified execution engine configured to translate a plurality of heterogenous protocols of the YAML connector into a single JSON request or response surface.

Aspect 19: The template-based connector architecture of aspect 18, wherein the multi-pass renderer performs a first pass in which a secret-placeholder resolution is performed against a vaulted credential store, a second pass in which typed web template engine-compatible expressions are evaluated, and a third pass in which one or more runtime validations are performed using declarative schema definitions.

Aspect 20: The template-based connector architecture of aspect 19, wherein runtime validation errors are surfaced as structured JavaScript object notation (JSON) exceptions including a path for a failing field and an associated type rule violated by the one or more runtime validations.

Aspect 21: The template-based connector architecture of any one of aspects 18 through 20, wherein the unified execution engine exposes a plurality of API adapters through a common execute endpoint.

Aspect 22: The template-based connector architecture of any one of aspects 18 through 21, further including: a schema-mapping component for performing bidirectional transformation between schemas for remote systems and an internal canonical model.

Aspect 23: The template-based connector architecture of any one of aspects 18 through 22, wherein the template-based connector architecture caches each compiled template under a secure hash algorithm 256-bit (SHA-256) digest of post-rendered content to prevent repeat execution of identical templates.

Aspect 24: A template-based connector architecture, including: a multi-pass renderer for receiving a YAML connector and rendering strings, dictionaries, and lists of the YAML connector recursively while validating types, substituting secrets, and caching compiled templates; a unified execution engine configured to translate a plurality of heterogenous protocols of the YAML connector into a single JavaScript object notation (JSON) request or response surface; and a bidirectional adapter configured to consume external model context protocol (MCP) tools via construction of local YAML connectors and expose internal commands or workflow as MCP endpoints, wherein each invocation of the internal commands or workflows is secured under a user-bound-agent token.

Aspect 25: The template-based connector architecture of aspect 24, wherein inbound MCP traffic is transported and validated using a WebSocket protocol and a demonstration of proof-of-possession-bound (DPoP-bound) access token.

Aspect 26: The template-based connector architecture of aspect 25, wherein outbound MCP calls are executed via the unified execution engine and returned to a calling agent using a single WebSocket protocol session.

Aspect 27: The template-based connector architecture of any one of aspects 24 through 26, wherein the bidirectional adapter includes a token-revocation stream for immediately terminating active MCP sessions associated with a revoked user-bound-agent token.

Aspect 28: The template-based connector architecture of any one of aspects 24 through 27, wherein the bidirectional adapter is operable to enable or disable individual commands at runtime for configuring internal workflows of MCP endpoints without a redeploy of the template-based connector architecture.

Aspect 29: The template-based connector architecture of any one of aspects 24 through 28, wherein the bidirectional adapter is operable to: expose one or more view-scoped endpoints that apply multi-dimensional filters; and support hot-reload of view definitions.

Aspect 30: The template-based connector architecture of any one of aspects 24 through 29, further including: a test endpoint operable to validate external MCP connectivity; and an apply endpoint operable to: generate system configuration instructions for the external MCP connectivity; create a scoped-view entry for the external MCP connectivity; and register the external MCP connectivity in a service graph.

Aspect 31: An apparatus or device including a memory comprising executable instructions, and a processor configured to execute the executable instructions and cause the apparatus to perform a method in accordance with any one of Aspects 1-30.

Aspect 32: An apparatus or device, including means for performing a method in accordance with any one of Aspects 1-30.

Aspect 33: A non-transitory computer-readable medium including executable instructions that, when executed by a processor of an apparatus, cause the apparatus to perform a method in accordance with any one of Aspects 1-30.

Aspect 34: A computer program product embodied on a computer-readable storage medium comprising code for performing a method in accordance with any one of Aspects 1-30.

### Additional Considerations

Aspects of the present disclosure are described herein with reference to flowchart illustrations and/or block diagrams of methods, apparatus (systems), and computer program products according to embodiments of the disclosure. It will be understood that each block of the flowchart il-lustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable pro-gram instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such as the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products ac-cording to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that per-form the specified functions or acts or conduct combinations of special purpose hardware and computer instructions.

“Real-time” can refer to the capability of a system or process to respond to inputs or events within a strict period of time, such as immediately or within seconds or milliseconds. In computing and information technology, real-time systems can be designed to process data and provide outputs instantaneously or almost instantaneously, ensuring minimal latency.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” can indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. An agent-centric workflow system, comprising:
one or more processors and a memory coupled to the one or more processors, the memory storing instructions that, when executed by the one or more processors, cause the system to implement:
a workflow engine operable to receive a workflow identifier and return a self-describing, zero-shot task payload, the workflow engine including:
a next path generator operable to identify a possible next step in an identified workflow, dependencies between nodes of the identified workflow, and a consequence of the possible next step in order to construct a dynamically-generated next path map, and
an agent context manager operable to construct the self-describing, zero-shot task payload including an executable request template, natural-language guidance, and success-criteria metadata for the possible next step; and
a large language model (LLM) agent including a natural language processor and operable to receive a machine-readable response and execute the self-describing, zero-shot task payload in a zero-shot execution, wherein the zero-shot execution includes execution of the identified workflow by the LLM agent without prior training on the identified workflow and without pre-registration of schemas or custom code.

2. The agent-centric workflow system of claim 1, wherein the next path generator constructs the dynamically-generated next path map as a mermaid-compatible graph including node labels corresponding to discrete workflow steps.

3. The agent-centric workflow system of claim 2, wherein the next path generator is operable to collapse the mermaid-compatible graph to a single path for linear sequences and operable to expand the mermaid-compatible graph into a tree structure to include conditional branches.

4. The agent-centric workflow system of claim 1, wherein the workflow engine further comprises:
a field validation module operable to validate an action of the self-describing, zero-shot task payload against a registry of permitted operations prior to passing the self-describing, zero-shot task payload to the LLM agent.

5. The agent-centric workflow system of claim 1, wherein the self-describing, zero-shot task payload includes an artificial intelligence (AI) context section, the AI context section including a secure hash algorithm 256-bit (SHA-256) checksum of the executable request template to detect tampering by downstream operators.

6. The agent-centric workflow system of claim 1, wherein the workflow engine is:
operable to render the self-describing, zero-shot task payload in a hypertext markup language (HTML) representation for operator approval prior to passing the self-describing, zero-shot task payload to the LLM agent.

7. An execution gateway for identity management systems, comprising:
a pluggable policy enforcement point operable to communicate a pending task payload with and receive a denial decision from an external policy-decision point; and
a redaction engine in communication with the pluggable policy enforcement point, the redaction engine operable to utilize the denial decision to sanitize one or more unauthorized operations from the pending task payload to construct a sanitized payload,
wherein the pluggable policy enforcement point further communicates the sanitized payload to the external policy-decision point for a further request.

8. The execution gateway of claim 7, wherein the pluggable policy enforcement point includes decision protocols compliant with multiple policy languages.

9. The execution gateway of claim 7, further comprising:
a deterministic attribute-based cache operable to store allowed decisions for a first hop limit and denied decisions for a second hop limit shorter than the first hop limit.

10. The execution gateway of claim 7, wherein the redaction engine further performs sanitization via masking of disallowed data fields using a placeholder token.

11. The execution gateway of claim 7, further comprising:
a continuous-access-evaluation (CAE) listener operable to ingest token-revoked CAE protocol events and purge corresponding cache entries within a pre-determined time limit.

12. The execution gateway of claim 11, wherein the pre-determined time limit is about 30 seconds.

13. A computer-implemented method for constructing a connector for a target application programming interface (API), comprising:
receiving external interface metadata for the target API;
parsing the external interface metadata in an artificial intelligence-based (AI-based) construction engine to extract instructions, constraints, states, and success criteria for a workflow;
generating, via the AI-based construction engine, an executable YAML connector including definitions and associated workflow nodes using the instructions, the constraints, the states, and the success criteria; and
registering the executable YAML connector for immediate runtime use without re-deploying the system.

14. The computer-implemented method of claim 13, wherein the executable YAML connector includes verb-to-operation mappings for each path item of the associated workflow nodes.

15. The computer-implemented method of claim 13, wherein the external interface metadata includes MCP tool descriptors and wherein the executable YAML connector includes a bi-directional schema for mapping parameters to a provider model and responses to a canonical model through a single schema.

16. The computer-implemented method of claim 13, wherein generating the executable YAML connector further includes:
performing an error-correction loop that includes initiating a dry-run call against a staging endpoint and amending the executable YAML connector in response to a failed call.

17. The computer-implemented method of claim 13, further comprising:
receiving a user override, via an interactive wizard, for amending default-type mappings of the executable YAML connector while generating the executable YAML connector.

18-23. (canceled)

24. A template-based connector architecture, comprising:
a multi-pass renderer for receiving a YAML connector and rendering strings, dictionaries, and lists of the YAML connector recursively while validating types, substituting secrets, and caching compiled templates;
a unified execution engine configured to translate a plurality of heterogenous protocols of the YAML connector into a single JavaScript object notation (JSON) request or response surface; and
a bidirectional adapter configured to consume external model context protocol (MCP) tools via construction of local YAML connectors and expose internal commands or workflow as MCP endpoints,
wherein each invocation of the internal commands or workflows is secured under a user-bound-agent token.

25. The template-based connector architecture of claim 24, wherein inbound MCP traffic is transported and validated using a WebSocket protocol and a demonstration of proof-of-possession-bound (DPoP-bound) access token.

26. The template-based connector architecture of claim 25, wherein outbound MCP calls are executed via the unified execution engine and returned to a calling agent using a single WebSocket protocol session.

27. The template-based connector architecture of claim 24, wherein the bidirectional adapter includes a token-revocation stream for immediately terminating active MCP sessions associated with a revoked user-bound-agent token.

28. The template-based connector architecture of claim 24, wherein the bidirectional adapter is operable to enable or disable individual commands at runtime for configuring internal workflows of MCP endpoints without a redeploy of the template-based connector architecture.

29. The template-based connector architecture of claim 24, wherein the bidirectional adapter is operable to:
expose one or more view-scoped endpoints that apply multi-dimensional filters; and support hot-reload of view definitions.

30. The template-based connector architecture of claim 24, further comprising:
a test endpoint operable to validate external MCP connectivity; and
an apply endpoint operable to:
generate system configuration instructions for the external MCP connectivity;
create a scoped-view entry for the external MCP connectivity; and
register the external MCP connectivity in a service graph.
